(19) United States
(12) Patent Application Publication
(10) Pub. No.: US 2023/0236016 A1
(43) Pub. Date: Jul. 27, 2023

(54) COMPUTER SYSTEM, APPARATUS, AND METHOD FOR AN AUGMENTED REALITY HAND GUIDANCE APPLICATION FOR PEOPLE WITH VISUAL IMPAIRMENTS

(71) Applicant: The Penn State Research Foundation, University Park, PA (US)

(72) Inventors: Nelson Daniel Troncoso Aldas, University Park, PA (US); Vijaykrishnan Narayanan, University Park, PA (US)

(21) Appl. No.: 18/011,996

(22) PCT Filed: Jul. 20, 2021
(86) PCT No.: PCT/US2021/042358

§ 371 Date: Dec. 21, 2022

Related U.S. Application Data
(60) Provisional application No. 63/054,424, filed on Jul. 21, 2020.

(51) Int. Cl. G01C 21/20; G06V 20/50; G06T 7/73; G06F 3/01; G06F 3/16; G06F 3/04817; G06F 3/0484; H04M 1/72403

(52) U.S. Cl. CPC G01C 21/20; G06V 20/50; G06T 7/73; G06F 3/016; G06F 3/167; G06F 3/04817; G06F 3/0484; H04M 1/72403; G06T 2207/30244; G06T 2200/24; G06T 2207/20092

(57) ABSTRACT

A system, device, application stored on non-transitory memory, and method can be configured to help a user of a device locate and pick up objects around them. Embodiments can be configured to help vision-impaired users find, locate, and pickup objects near them. Embodiments can be configured so that such functionality is provided locally via a single device so the device is able to provide assistance and hand guidance without a connection to the internet, a network, or another device (e.g. a remote server, a cloud based server, a server connectable to the device via an application programming interface, API, etc.).

### CROSS-REFERENCE TO RELATED APPLICATIONS

The present application is the U.S. national stage application of International Patent Application No. PCT/US2021/042358 filed on Jul. 20, 2021, which claims priority to U.S. Provisional Patent Application No. 63/054,424, which was filed on Jul. 21, 2020. The entirety of this provisional patent application is incorporated by reference herein.

### STATEMENT REGARDING FEDERALLY SPONSORED RESEARCH

This invention was made with government support under Grant No. CCF1317560 awarded by the National Science Foundation. The Government has certain rights in the invention.

### FIELD

The present innovation related communication systems, computer systems, input device systems, and methods of making and using the same. Embodiments can utilize assistive technologies, accessibility technologies and/or mixed/augmented reality technologies. Some embodiments can be adapted for utilization in conjunction with a mobile device (e.g. smart phone, smart watch, tablet, laptop computer, application stored on memory of such a device, etc.).

### BACKGROUND

Finding objects, from a cereal-box to a medicine-bottle, can be a critical task in people's daily lives. For people with visual impairments, this task can be a significant undertaking. It might involve using other sensory skills or requesting assistance from a sighted person who might not always be available. Several assistive technologies exist today to help people with visual impairments become more independent, including computer vision systems and remote-sighted-assistance applications. Remote-sighted-assistance applications connect users to either agents or volunteers, with Aira and BeMyEyes as well-known examples. Although these applications have a high success rate in solving the task at hand, some of them come with a monetary cost and raise privacy concerns resulting from assistive requests to strangers.

There are two object detection mechanisms mainly used by camera-based assistive applications for object finding: human assistive object detection and automatic object detection based on computer vision algorithms. Object finding applications using human assistance exploit crowdsourcing or sighted human agents providing real time feedback. Well-known applications are Aira, BeMyEyes, and VizWiz. Aira employs professional agents that assist users through a conversational app interface. BeMyEyes connects users to crowdsourced volunteers. VizWiz accepts photos and questions from users and provides feedback through text. Such remote assistive applications are popular among people with visual impairments due to a high success rate at finding target objects. However, these systems come with a monetary cost, need an internet connection, and raise privacy concerns resulting from assistive requests to strangers.

In recent years, computer vision-based applications, driven by advances in visual sensing and mobile technology, have improved dramatically. Nowadays, these applications can serve users to identify products (scanning barcodes), read documents, find people (by recognizing faces), identify currency bills, detect lighting, read handwritten-text and get a scene description. However, one feature that these systems lack is the ability to provide the relative position of the object of interest. Furthermore, these systems do not address the issue of locating and acquiring objects in arm reachable distance, known as the last meter problem.

Directional hand guidance applications assist a variety of tasks for users with visual impairment, including physically tracing printed text to hear text-to-speech output, learning hand gestures, and localizing, and acquiring desired objects. There are two different approaches for directional hand guidance: non-visual and visual. For non-visual directional hand guidance, previous works focused on exploiting audio and haptic feedback to find targets and trace paths with visually impaired users' hands. Oh et al. exploited different attributes of sound and verbal feedback for users with visual impairment to learn shape gestures. Sonification is used to guide users with visual impairment reach targets in their peripersonal space. Tactile feedback from a hand-held device is exploited to find targets on a large wall-mounted display. Wristbands with vibrational motors are used for target finding and path tracing.

For visual directional hand guidance, visual information was collected from cameras to provide multimodal feedback for hand guidance. Text recognition, along with audio and tactile feedback, is exploited for a finger-worn text reader. Well-known examples are FingerReader and HandSight, allowing users to physically-trace printed text to hear text-to-speech-output. A camera mounted to wearable glasses has been used to provide audio feedback based on a camera field of view to allow users to reach target objects. Hololens has been used to magnify text and images collected from a finger camera for users with low vision. To identify and track target objects, a camera mounted on a glove has been proposed to guide hand movements and the orientation of the users and to send video streams to the server, where computer vision algorithms analyze them. Although previous works on hand guidance to a target found hand-held devices effective in automatic hand tracking, the systems lack precise hand location information, which is critical in the real-world environment.

Different types of directional information have been evaluated for various assistive tasks for users with visual impairment, including auditory channel, the haptic modality, or a combination of both. An assistive photography application was proposed and found speech feedback better for users than tone feedback for ease of use. A spatial ontology for verbal transcription of OpenStreetMap data has also been proposed. Vizlens, a real-time interactive screen reader providing audio feedback from crowdsourcing has also been utilized.

Access Lens provides verbal feedback to users' gestures on physical objects and paper documents. ABBI is another auditory system that exploits sonification to provide information about the position of the hand. GIST provides verbal feedback based on users' gestures to offer spatial perception. A combination of haptic and auditory directional guidance for a finger-worn text reader has also been evaluated. Additionally, smartphone apps with auditory and tactile feedback that find text posted in various indoor environments have been evaluated. A personalized assistive indoor navigation system providing customized auditory and tactile feedback to users based on their specific information needs and wayfinding guidance using visual and audio feedback on Microsoft Hololens for users with low vision have also been studied or evaluated.

### SUMMARY

We determined that the ubiquity of smartphones among people with visual impairments has generated a large body of research and development of mobile device-based assistive applications. These systems accommodate tasks, including object recognition, object search, text recognition and navigation. Most of these systems require an internet connection, and some of them require augmenting the physical environment with sensors or landmarks. For users in locations with an unreliable internet connection, the use of online applications can become frustrating; this makes offline applications an attractive alternative. Although systems that require augmenting the physical environment are effective at assisting users, these systems are impractical to be widely deployed due to cost and maintenance.

For example, in addressing the last meter problem, ThirdEye, an automatic shopping assistant system that recognizes grocery items in real-time video streams using cameras mounted on glasses and a glove was proposed. Another example is a proposed system that utilizes a camera mounted on glasses, bone conduction headphones, and a smartphone application. This system takes visual input from the camera, processes that information on a backend server to detect and track the object, and provides auditory feedback to guide the user. We determined that the drawback of such systems with specialized hardware is its limited scalability, its bulkiness might be impractical for daily use, and it requires wireless connection to either the internet or a server. Another system that was proposed requires the user to capture an initial scene image, requests annotation from crowdsource, and utilizes that information for guidance. However, this asynchronous system depends on the quality of captured images, crowdsource availability, internet connection, and raises concerns due to strangers interacting with them.

We have determined that these conventional applications have problems related to providing the relative location of objects in three dimensional space (3D-space) and they do not address the issue of picking up objects. Embodiments of our proposed solution, in contrast, can overcome such problems. In some embodiments, such problems are overcome by harnessing the power of augmented reality frameworks, such as ARKit and ARCore, which provide a real-time estimate of the device's pose and position relative to the real-world based on information from camera and motion-sensing hardware of a smart phone or other mobile computer device having a processor connected to non-transitory memory, the camera, and the motion sensing hardware (e.g. accelerometer, etc.).

In some embodiments, a non-transitory computer readable medium of a computer device (e.g. an application stored on memory of a smart phone) can be provided. The application can be configured so that when the processor of the device runs the application, the device is configured to help a user find and pick objects from their surroundings. The application can be designed to use Apple's augmented reality framework, ARKit, to detect objects in 3D space and track them in real-time for iOS based smart phones, for example. To guide the user's hand to the object of interest, the application can be structured so that when the code of the application is run, the smart phone that runs the application provides speech feedback along with optional haptic and sound feedback. Also, to address privacy concerns, the application can be structured so that when the code of the application is run, the smart phone or other mobile computer device running the application does not transmit acquired camera images to a remote server, and all the computations are locally performed by the mobile device (e.g. smart phone, etc.). Embodiments can therefore be configured as a self-contained device application that does not require a custom infrastructure, and it does not need a cellular or Wi-Fi connection or other type of internet connection for connecting to any server or remote server etc. (e.g. the application can be configured as a self-contained application for a smart phone, tablet, laptop computer, or other computer device that can function without a communicative connection to another remote device via the internet or other type of network connect etc.).

In some embodiments, a self-contained smartphone application, tablet application, or personal computing application can be provided that is structured and configured so that it does not need external hardware nor an internet connection to allow the functionality of a smart phone or other mobile device defined by the application to be provided. Embodiments can be structured and configured so that, when the application is run, the device running the application can provide the relative position in 3D-space of objects in real-time and can provide output that guides the user to the object of interest by using haptic, sound, and/or speech feedback. In some embodiments of our application, the application can be configured so that the device running the application can evaluate multimodal feedback, a combination of audio and tactile, incorporated into a standard phone accessibility interface. Embodiments can be configured to leverage technology, e.g., augmented reality frameworks, currently supported by millions of phones available in the market as well as other mobile devices available in the market.

For example, a mobile device can be configured to concurrently track a position of a hand of the user and a location of an object based on camera data of an area around the object and sensor data of the mobile device to generate audible and/or tactile instructions to output to a user to guide the user to the object independent of whether the object is within a line of sight of the camera after the location of the object is determined and also independent of whether a hand of the user is in sight of the camera. The mobile device can be configured to provide such functionality as a stand-alone system (e.g. without use of other devices for performing processing of aspects of the functionality to be provided by the mobile device such as an API interface to a server, for example).

Embodiments of a method of providing hand guidance to direct a user toward an object via a mobile device so that the user can pick up or otherwise manually manipulate the found object with the user's hand can is provided. Embodiments of a mobile device and a non-transitory computer readable medium configured to facilitate implementation of embodiments of the method are also provided. Embodiments of the method can include a mobile device responding to input selecting an item to be found by utilizing at least one camera of the mobile device to receive camera data of an area around the mobile device, identifying an object that is the selected item to be found from the camera data, determining a location of the object in the area around the mobile device in response to identifying the object, and providing audible instructions and/or tactile instructions via the mobile device to the user to instruct the user where to move based on a position of the camera and the determined location of the object in the area around the mobile device.

The providing of the audible instructions can include periodic emission of sound to indicate a proximity of the camera to the object and audible directional instruction output to the user to change a direction of the camera to move the mobile device closer to the object based on the determined location of the object in the area around the mobile device and a position of the camera relative to the determined location of the object. For instance, the frequency of a sound that is to be emitted via a speaker of the mobile device or via at least one speaker of a peripheral device (e.g. ear buds, a Bluetooth speaker, etc.) can be changed to indicate whether the user is moving closer to an object or further from an object. A direction of the sound (e.g. emitted out of a left ear bud or left ear phone, sound emitted out of a right ear bud or right ear phone, sound emitted to be a rightwardly sound output, sound emitted to be a leftwardly sound output, etc.) can be adjusted to indicate to the user that the camera should be moved leftwards, upwards, downwards or rightwards.

The providing of the tactile instructions can include, for example, generation of vibrational signals or braille interface signals to provide tactile output to the user (e.g. hand of user, wrist or arm of user, leg or waist of user, head of user, etc.). The tactile instructions can include haptic feedback, for example. The tactile instructions can include vibrations or other tactile output that indicate a proximity of the camera to the object and to change a direction of the camera to move the mobile device closer to the object based on the determined location of the object in the area around the mobile device and the determined position of the camera relative to the determined location of the object. For instance, the frequency of vibration can be changed to indicate whether the user is moving closer to an object or further from an object. A direction of the vibration can be adjusted to indicate to the user that the camera should be moved leftwards, upwards, downwards or rightwards.

The determining of the location of the object in the area around the mobile device can include generating a pre-selected number of location samples via ray casting and determining the location via averaging predicted locations determined for the pre-selected number of location samples such that the determined location is an average predicated location based on predicated locations determined for all the pre-selected number of location samples. The determined location can also be subsequently updated by obtaining a moving average based on a generation of additional location samples obtained via ray casting while the user moves the mobile device toward the object in response to the provided audible instructions and/or tactile instructions.

A graphical user interface (GUI) can be generated on a display of the mobile device that displays a list of selectable items to facilitate the receipt of the input selecting the item to be found. The GUI can also be updated after the item is selected to display an actuatable icon (e.g. selectable icon that can be selected via a touch screen display, pointer device, etc.) to facilitate receipt of input to initiate the providing of the audible instructions and/or tactile instructions to provide navigational output to the user to help the user find and manipulate the object.

In some embodiments, the identification of the object can occur by mobile device being moved by the user to use camera (e.g. at least one camera sensor of the mobile device) to capture images of surrounding areas within a room, building, or other space to locate the item and identify its location relative to the user (e.g. by recording video of the area around the mobile device). This camera data can then be utilized to track the localization of the item with respect to the mobile device. The mobile device can provide output to help facilitate the user's actions. For example, audible and/or text output can be provided to the user via the GUI and/or audible output from a speaker to tell the user to move the camera in front of the user so that the mobile device can tell the user when it has found the item via the recorded video captured by the camera that can occur as a result of the user moving the mobile device around an area to capture images of the surrounding areas. While the user moves the mobile device around to identify the object, the mobile device can emit output (e.g. via a speaker) to remind the user that it is searching for the item (e.g. by audibly outputting “Scanning” every 5 seconds or other time period alone or in combination with displaying the term on GUI, etc.). Once the selected item and its location are detected via the camera sensor data, the mobile device can update the guidance GUI and also emit an audible notification sound to inform the user that the item was found.

The mobile device can be configured to identify the user selected object from the camera data (e.g. recorded video data, captured images, etc.) and at least one location sample can then be generated. The location sample(s) can be generated via ray casting utilizing the camera sensor data for detection of a feature point for the object. In some embodiments, if there are less than a pre-selected number of localization samples, then additional localization samples can be generated via the ray casting process until there is at least the pre-selected number of samples. In other embodiments, only a single localization sample may be necessary to meet the pre-selected number of localization samples threshold. Once the sample threshold is reached, a predicted location of the object can be determined by the mobile device. This predicted location can be an initial predicted location (e.g. a first predicted location) and can be designed to identify a centroid of a point cloud generated by the repeated ray casting operations used to obtain the initial number of localization samples (e.g. at least 50 samples, at least 100 samples, at least 150 samples, 150 samples, 200 samples, between 50 and 500 samples, etc.). Utilization of a number of samples to generate the predicted initial location as a mean of the predicted locations obtained from for all of the initial localization samples was found to provide an enhanced accuracy and reliability of accurately identifying the actual location of the identified object.

The mobile device can also update its predicted location for the object by utilization of a moving average. For example, the initial predicted location can subsequently be compared to a moving average of the predicted location for new additional location samples that can be collected after the camera is moved as the mobile device is moved by a user to be closer to the object in response to audible instructions and/or tactile instructions provided by the mobile device to the user to guide the user closer to the object to help the user find the objet. The updating of the localization samples can be utilized to provide an updated moving predicted location via a moving average step that accounts for motion of the mobile device and camera so that at least one new location sample would be obtained for updating the predicted location based on movement of the mobile device Use of the moving average feature can allow the mobile device to update the predicted location to account for improved imaging and ray casting operations that may be obtained as the camera moves closer to the detected object. The sample size for the moving average can be set to a pre-selected moving average sample size so that the samples used to generate the updated predicted location accounts for the most recently collected samples within the pre-selected moving average sample size. In some embodiments, the pre-selected moving average sample size can be the same threshold of samples as the initial localization threshold number of samples. In other embodiments, these threshold numbers of samples can differ (e.g. be more or less than the pre-selected number of samples for generating the first, initial location prediction for the object).

As the mobile device is moved during the motion of the user to locate the target object, older localization samples can be discarded and more recently acquired localization samples obtained via the camera and the ray casting operation can replace those discarded samples to update the determined predicted location. If the predicted location is updated to a new location, the guidance provided to a user can also be updated to account for the updated predicted location.

The mobile device can provide audible instructions and/or tactile instructions to the user to provide for horizontal motion of the user to move closer to the determined position of the identified object. In some embodiments, the type of horizontal direction instruction to provide can be determined by a horizontal direction instruction process that includes: (1) obtain a transform from an anchor representing the object and the transform from the camera data; and (2) extract the object position from both transforms while setting the y value to 0. The position of these two transform vectors are with respect to the World Origin, which the basis of the AR world coordinate space. By default, the World Origin is based on the initial position and orientation the device's camera at the beginning of an AR session. The process can then proceed with (3) getting the normal of the anchor with respect to the camera position and define this normal of the anchor as a normal vector object; (4) creating a new transform front of the camera and defining that new transform front of the object, (5) extract the new transform position while setting the y value to 0, (6) get the normal of the new point position of the camera front with respect to the camera position, (7) obtain the dot product between these normal values, (8) get the angle between the new point position of the camera and the object anchor by taking the arccosine of the dot product from step 7, which can provide a magnitude of the angle, a value between 0 and 180. Then, in a step 9, the device can get the cross product between the normal values, which can allow the mobile device to distinguish right from left. If the y value of the normal position is negative and between 0 and 120 degrees, then the camera is looking to the right of the object and the user needs to be informed to move to the left by the mobile device's audible instructions and/or tactile instructions. If the y value of the normal position is positive and between 0 and 120 degrees, the camera is looking to the left of the object and the user need to be told to move to the right by the audible instructions and/or tactile instructions output via the mobile device. If the absolute value of the positive or negative angle is greater than 120 (e.g. is −120°-180° or 120°-180°), then the object is behind the camera and the user is to be informed that the object is behind the camera or the mobile device via the audible instructions and/or tactile instructions output via the mobile device.

The mobile device can be configured to utilize a different algorithm to determine the vertical directional guidance (e.g. up or down) to be provided via the audible instructions and/or tactile instructions output via the mobile device. Instead of considering an angle between a vector projected in front of the camera and another to the object as utilized in the exemplary horizontal directional guidance algorithm discussed above, a height between the camera and the object can be utilized. If the y difference between the camera position and the object is positive, then the camera (and mobile device 1) can be above the object. If the y difference between the camera position and the object is negative, the camera (and mobile device 1) can be below the object. To show the distance information between the camera view and the object, the distance between them can be considered while ignoring the height difference. The mobile device can, for example, extract the position from the anchor included in the camera data, and camera transforms while ignoring the “y” value. Then, the camera position can be subtracted from the anchor position. The magnitude of this value can subsequently be extracted. If the y difference between the camera position and the object is positive, then the mobile device can determine that it and the camera are above the object and the audible instructions and/or tactile instructions should inform the user to move the camera down or downwardly. If the y difference between the camera position and the object is negative, the mobile device can determine that the camera and mobile device are below the object and the audible instructions and/or tactile instructions should inform the user to move the camera upwards or upwardly.

The positional adjustments of the camera made by the user can result in the mobile device subsequently re-running its horizontal and vertical positioning algorithms to determine new positional changes that may be needed in a similar manner and subsequently provided updated audible output of instructions to the user for the user to continue to move the camera closer to the object. Once the user reaches the object, the user can manipulate the object with the user's hand. When the mobile device determines that the camera is at the object or within a pre-selected proximity of the object, audible instructions and/or tactile instructions can be output so that the user can grasp the object or handle the object. For instance, to help provide additional audible instructions related to the user's proximity to the object, the mobile device can output a beeping sound or other sound periodically and adjust the period at which this sound is emitted so that the sound is output less often when the user moves away from the object to inform the user that he or she has moved farther from the object and the period of the sound emission can be shortened so the sound is output more often to inform the user that he or she has moved closer to the object. The adjustment of the period at which the sound is emitted can occur as the camera is moved by the user based on the determined proximity of the mobile device to the determined location of the object.

As another example, to help provide additional tactile instructions related to the user's proximity to the object, the mobile device can output a vibration periodically and adjust the period at which this vibration is emitted so that the vibration is output less often when the user moves away from the object to inform the user that he or she has moved farther from the object and the period of the vibrational emission can be shortened so the vibration is output more often to inform the user that he or she has moved closer to the object. The adjustment of the period at which the vibration is emitted can occur as the camera is moved by the user based on the determined proximity of the mobile device to the determined location of the object.

It should be understood that the object that can be detected can be any type of object. The object to which the user is guided can be any type of physical object (e.g. animal, thing, device, etc.). For example, the object can be an animal (e.g. a pet, a child, etc.), a toy, a vehicle, a device (e.g. a remote control, a bicycle, a camera, a box, a can, a vessel, a cup, a dish, silverware, a phone, a light, a light switch, a door, etc.), or any other type of object.

In some embodiments, a mobile device can be designed for providing hand guidance to direct a user toward an object. The mobile device can include a processor connected to a camera and a non-transitory computer readable medium having an application stored thereon. The mobile device can be configured to concurrently track a position of a hand of the user and a location of an object based on camera data of an area around the object and sensor data of the mobile device to generate audible instructions and/or tactile instructions to output to a user to guide the user to the object independent of whether the object is within a line of sight of the camera after the location of the object is determined and also independent of whether a hand of the user is in sight of the camera.

In some embodiments, the mobile device can include a processor connected to a non-transitory computer readable medium having an application stored thereon. The application can define a method that is performed when the processor runs the application. The method can include responding to input selecting an item to be found by utilizing at least one camera of the mobile device to receive camera data of an area around the mobile device, identifying an object that is the selected item to be found from the camera data, determining a location of the object in the area around the mobile device in response to identifying the object, and providing tactile instructions and/or audible instructions via the mobile device to the user to instruct the user where to move based on a position of the camera and the determined location of the object in the area around the mobile device.

A non-transitory computer readable medium having an application stored thereon is also provided. The application can define a method that can be performed by a mobile device when a processor of the mobile device runs the application. The method can include responding to input selecting an item to be found by utilizing at least one camera of the mobile device to receive camera data of an area around the mobile device, identifying an object that is the selected item to be found from the camera data, in response to identifying the object, determining a location of the object in the area around the mobile device, and providing tactile instructions and/or audible instructions via the mobile device to the user to instruct the user where to move based on a position of the camera and the determined location of the object in the area around the mobile device.

In some embodiments, the determining of the location of the object in the area around the mobile device can include (i) utilization of ray casting, (ii) using a deep learning/machine learning/artificial intelligence to directly get the three dimensional location of the object from the camera data so that the object location is determined with respect to the camera, or (iii) utilizing feature matching to obtain the three dimensional location of the object with respect to the camera.

Embodiments can also be configured so that a pre-selected number of location samples are obtained and the location of the object is determined via averaging predicted locations determined for the pre-selected number of location samples such that the determined location is an average predicted location. For example, a pre-selected number of location samples can be obtained via ray casting and the location of the object can be determined via averaging predicted locations determined for the pre-selected number of location samples such that the determined location is an average predicted location.

The determined location can also be updated to account for subsequent motion of a user and/or the camera. For instance, the determined location can be updated by obtaining a moving average based on a generation of additional location samples obtained via ray casting while the user moves the mobile device toward the object in response to the provided tactile instructions and/or audible instructions. Such updating can alternatively be obtained via using a deep learning/machine learning/artificial intelligence to directly get the three dimensional location of the object from the camera data so that the object location is determined with respect to the camera, or utilizing feature matching to obtain the updated three dimensional location of the object with respect to the camera. In some embodiments, the determination of the object location and/or updating of the object location can include determining the position of the camera relative to the determined location of the object in the area around the mobile device, updating the determined location of the camera relative to the determined location of the object in the area around the mobile device to account for movement of the camera that occurs in response to the providing of the tactile instructions and/or audible instructions, and providing updated tactile instructions and/or audible instructions via the mobile device to the user to instruct the user where to move based on the determined updated position of the camera and the determined location of the object in the area around the mobile device. In such embodiments, the position of the camera can be a proxy for a hand of the user.

The determining of the position of the camera relative to the determined location of the object can be based on sensor data obtained via at least one sensor of the mobile device. The at least one sensor data can be, for example, the camera, at least on lidar sensor, an accelerometer, a combination of such sensors. Other sensors can also be utilized alone or in combination with one or more of these sensors.

The mobile device can be a machine. For example, the mobile device can be a cell phone, a tablet, a mobile communication terminal, a smart phone, or a smart watch.

Embodiments can also be configured for use with a graphical user interface (GUI) that can be displayed on a display of the mobile device (e.g. mobile device screen, etc.). In some embodiments, a GUI can be generated on a display of the mobile device to display location information based on the determined location of the object in the area around the mobile device and the position of the camera. The GUI can also be updated in response to selection of a guide icon to initiate the mobile device performing the providing of the tactile instructions and/or audible instructions via the mobile device to the user to instruct the user where to move so the user moves toward the object based on the position of the camera and the determined location of the object in the area around the mobile device.

The tactile instructions and/or audible instructions can include only audible instructions, only tactile instructions, or a combination of audible and tactile instructions. In some embodiments, the providing of the tactile instructions and/or the audible instructions can include periodic emission of sound to indicate a proximity of the camera to the object and providing audible directional instruction output to the user to change a direction of the camera to move the mobile device closer to the object based on the determined location of the object in the area around the mobile device and a position of the camera relative to the determined location of the object. In some embodiments, the providing of the tactile instructions and/or the audible instructions can also (or alternatively) include periodic emission of tactile output to indicate a proximity of the camera to the object and providing tactile directional instruction output to the user to change a direction of the camera to move the mobile device closer to the object based on the determined location of the object in the area around the mobile device and a position of the camera relative to the determined location of the object.

A method of providing hand guidance to direct a user toward an object via a mobile device is also provided. Embodiments of the method can be configured to utilize an embodiment of the mobile device and/or non-transitory computer readable medium. For example, some embodiments of the method can include a mobile device responding to input selecting an item to be found by utilizing at least one camera of the mobile device to receive camera data of an area around the mobile device, the mobile device identifying an object that is the selected item to be found from the camera data; the mobile device determining a location of the object in the area around the mobile device in response to identifying the object, and providing audible instructions and/or tactile instructions via the mobile device to the user to instruct the user where to move based on a position of the camera and the determined location of the object in the area around the mobile device.

In some embodiments, the providing of the audible instructions can include periodic emission of sound to indicate a proximity of the camera to the object and outputting audible directional instructions to the user to change a direction of the camera to move the mobile device closer to the object based on the determined location of the object in the area around the mobile device and a position of the camera relative to the determined location of the object. The providing of the tactical instructions can include periodic emission of tactical output to indicate a proximity of the camera to the object and outputting tactical directional instructions to the user to change a direction of the camera to move the mobile device closer to the object based on the determined location of the object in the area around the mobile device and a position of the camera relative to the determined location of the object.

In some embodiments, the determining of the position of the camera relative to the determined location of the object can be based on sensor data obtained via at least one sensor of the mobile device. The at least one sensor data can be, for example, the camera, at least on lidar sensor, an accelerometer, a combination of such sensors. Other sensors can also be utilized alone or in combination with one or more of these sensors. For example, in some embodiments of the method, the determining of the location of the object in the area around the mobile device can include (i) utilization of ray casting, (ii) using a deep learning/machine learning/artificial intelligence to directly get the three dimensional location of the object from the camera data so that the object location is determined with respect to the camera, or (iii) utilizing feature matching to obtain the three dimensional location of the object with respect to the camera. Embodiments of the method can also be configured so that a pre-selected number of location samples are obtained and the location of the object is determined via averaging predicted locations determined for the pre-selected number of location samples such that the determined location is an average predicted location. For example, a pre-selected number of location samples can be obtained via ray casting and the location of the object can be determined via averaging predicted locations determined for the pre-selected number of location samples such that the determined location is an average predicted location.

The determined location can also be updated to account for subsequent motion of a user and/or the camera. For instance, the determined location can be updated by obtaining a moving average based on a generation of additional location samples obtained via ray casting while the user moves the mobile device toward the object in response to the provided tactile instructions and/or audible instructions. Such updating can alternatively be obtained via using a deep learning/machine learning/artificial intelligence to directly get the three dimensional location of the object from the camera data so that the object location is determined with respect to the camera, or utilizing feature matching to obtain the updated three dimensional location of the object with respect to the camera. In some embodiments, the determination of the object location and/or updating of the object location can include determining the position of the camera relative to the determined location of the object in the area around the mobile device, updating the determined location of the camera relative to the determined location of the object in the area around the mobile device to account for movement of the camera that occurs in response to the providing of the tactile instructions and/or audible instructions, and providing updated tactile instructions and/or audible instructions via the mobile device to the user to instruct the user where to move based on the determined updated position of the camera and the determined location of the object in the area around the mobile device. In such embodiments, the position of the camera can be a proxy for a hand of the user.

Embodiments of the method can also include generating a graphical user interface (GUI) on a display of the mobile device that displays a list of selectable items to facilitate the receipt of the input selecting the item to be found. The display of the mobile device can also be updated in response to receipt of the input selecting the item to be found on the display of the mobile device to display a selectable guide icon in the GUI that is selectable to initiate the mobile device performing the providing of the audible instructions and/or the tactile instructions.

Other details, objects, and advantages of the invention will become apparent as the following description of certain exemplary embodiments thereof and certain exemplary methods of practicing the same proceeds.

### BRIEF DESCRIPTION OF THE DRAWINGS

Exemplary embodiments of a mobile computer device (e.g. a smart phone, a tablet, a smart watch, etc.), a non-transitory computer readable medium, and a hand guidance system are shown in the accompanying drawings and certain exemplary methods of making and practicing the same are also illustrated therein. It should be appreciated that like reference numbers used in the drawings may identify like components.

FIG. 1 is a block diagram of an exemplary embodiment of a mobile computer device.

FIG. 2 is a flow chart illustrating a first exemplary embodiment of a method of hand guidance for selection and finding of an object.

FIG. 3 is a flow chart illustrating an exemplary embodiment of a localization step of the exemplary method illustrated in FIG. 2.

FIG. 4 is a block diagram of an item selection interface for an exemplary graphical user interface (GUI) that can be generated on a display 13 of the first exemplary embodiment of the mobile computer device.

FIG. 5 is a block diagram of a hand guidance interface for the exemplary GUI that can be generated on a display 13 of the first exemplary embodiment of the mobile computer device.

FIG. 6 is a block diagram of a settings interface for the exemplary GUI that can be generated on a display 13 of the first exemplary embodiment of the mobile computer device.

FIG. 7 is a block diagram of a tutorial interface for the exemplary GUI that can be generated on a display 13 of the first exemplary embodiment of the mobile computer device.

FIG. 8 is a graph illustrating the mean of the time spent in the guiding phase for participants of a study in which different objects were to be found using an embodiment of the mobile device.

### DETAILED DESCRIPTION

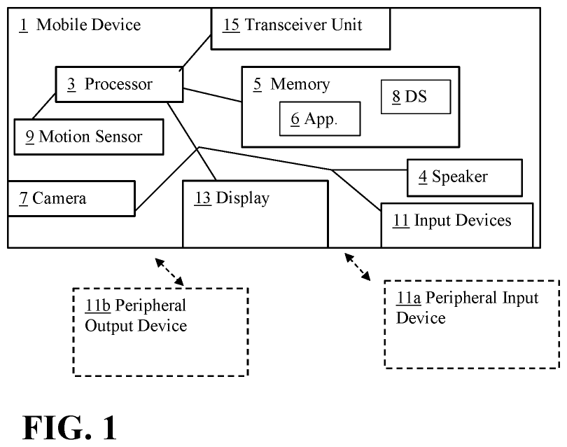

Referring to FIGS. 1-7, an exemplary embodiment of a mobile device can include a processor 3 connected to a non-transitory computer readable medium, such as non-transitory memory 5. The memory 5 can be flash memory, solid state memory drive, or other type of memory. At least one application (App.) 6 can be stored on the memory. At least one other data store (DS) 8 can also be stored on the memory. The data store can include at least one database or other type of file or information that may be utilized by the application (App.) 6. The application (App.) 6 can be defined by code that is stored on the memory and is executable by the processor so that the mobile device is configured to perform one or more functions when running the application. The one or more functions can include performance of at least one method defined by the application.

The mobile device 1 can be configured as a laptop computer, a smart phone, a smart watch, a tablet, or other type of mobile computer device (e.g. a mobile communication terminal, a mobile communication endpoint, etc.). The application (App.) 6 can be configured to be run on a mobile device that utilizes a particular type of operating software stored on the device's memory and run by the device's processor 3 (e.g. iOS software provided by Apple, Windows software provided by Microsoft, Android software provided by Google, etc.) The processor 3 can be a hardware processor such as, for example, a central processing unit, a core processor, unit of interconnected processors, a microprocessor, or other type of processor.

The mobile device 1 can include other elements. For example, the mobile device can include at least one output device such as, for example, speaker 4 and display 13 (e.g. a liquid crystal display, a monitor, a touch screen display, etc.), at least one camera sensor (e.g. camera 7), an input device (e.g. a keypad, at least one button, etc.), at least one motion sensor 9 (e.g. at least one accelerometer), and at least one transceiver unit (e.g. a Bluetooth transceiver unit, a cellular network transceiver unit, a local area wireless network transceiver unit, a Wi-Fi transceiver unit, etc.). The processor 3 of the mobile device can be connected to all of these elements (e.g. camera 7, speaker 4, display 13, motion sensor 9, transceiver unit 15, input device 11, other output device, etc.).

The mobile device 1 can also be configured to be communicatively connected to at least one peripheral input device 11a and/or at least one peripheral output device 11b as shown in broken line in FIG. 1. A peripheral input device can include a headset having a microphone, a stylus, or a pointer device (e.g. a mouse), for example. A peripheral output device 11b can include ear buds, headphones, a glove having at least one vibrational mechanism, a watch having a vibrational mechanism and/or at least one speaker (e.g. a Bluetooth speaker, etc.). The peripheral devices can be connected to the processor 3 via a wireless communicative connection or a wired connection (e.g. via a Bluetooth connection or a port of the device).

The mobile device 1 running the application (App.) 6 can provide guidance functionality for finding and manipulating (e.g. picking up, handling, etc.) an object. The application can be configured so that the mobile device running the application utilizes audio output (e.g. speech, emitted sound, etc.), and/or haptic feedback to provide directional instructions to a user to navigate the user's hand to a desired object.

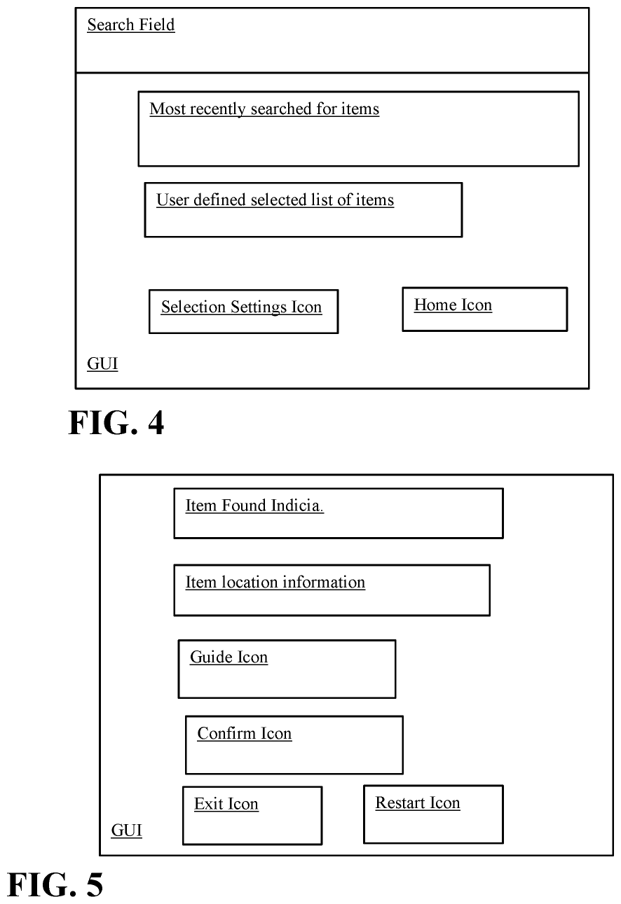

The application (App.) 6 can include code that is configured to define a graphical user interface (GUI) that can include multiple different screen displays. The application GUI can include subset GUIs such as, for example, a home GUI, an object selection interface GUI, a guidance GUI, a settings GUI display, and a tutorial GUI. Examples of the object selection, guidance, settings, and tutorial GUIs that can be generated by a mobile device 1 for being illustrated on a touch screen display 13 can be appreciated from the exemplary embodiment GUIs shown in FIGS. 4-7. The GUIs that are generated can include one or more icons that can be displayed such that a user touching the icon displayed on the screen with a user's finger or a user utilizing a pointing device (e.g. mouse, stylus, etc.) to actuate the displayed icon and provide input to the processor 3 for initiating a function defined by the application (App.) 6. The generation of the GUIs can be defined by the code of the application and be performed by the processor running the code to cause the display 13 to illustrate the GUIs.

For example, referring to FIG. 4, an object selection GUI can be illustrated in response to a user providing input to the mobile device to run the item selection or hand guidance application 6. Such an initiation of the program on the mobile device can be due to a user providing input to open that application via a home screen interface of the display of the mobile device 1, for example.

The object selection GUI that is illustrated can provide a display that permits a user to enter input to the mobile device 1 to select an item to be searched for and located so that guidance can be provided to the user to find and grasp, pickup, or otherwise manipulate the item to be searched for and found. The GUI for object selection can include a table and a search bar to help facilitate a user providing this input. The displayed table can include a list of most recently searched for items so that a user can select a particular item on the list to provide input to the mobile device 1 that the item to be found is that item. The GUI can also illustrate a defined selected list of items, which can be a list of items that user has defined as being favorite items or items that may be most often searched for so that such items are easily shown and selectable via that table or listing. The one or more lists of items that can be displayed can be defined in a data store (DS) 8 stored in the memory 5 that is a data store of the application or associated with the application 6. The data store 8 can be a database or other type of file that the processor running the application can call or otherwise access for generating the lists of items to be displayed in the GUI.

The lists of items displayed via the selection GUI can include one or more tables that presents the names of objects in a scrollable column list of clickable rows. The search field can be configured to permit a user to filter the displayed table of selectable items. The search field can be configured so that a user can provide voice-to-text input via an input device of the mobile device (e.g. a microphone) or by providing text input via a keyboard, keypad, or use of a touch screen display for typing letters or other characters into the search field. The displayed table(s) of items can also be defined in at least one data store 8. One such data store can be a file sent to the mobile device 1 for storage in the memory 6 by a vendor or retailer (e.g. a grocery store providing a database file listing items available for purchase that is transmittable to the mobile device 1 for storage in its memory via a local area wireless network connection, etc.). Another example of such a data store 8 can be a database file formed by the user or obtained from a server of another vendor via a communication connection with a server of that vendor for defining a particular listing of selectable items.

Other actuatable icons can also be provided on the GUI for item selection so a user can navigate the GUI to another interface display (e.g. another GUI display of the application) for providing other input to the mobile device 1. For example, there can be a home icon and a selection settings icon. The selection settings icon can be selectable so that a settings adjustment GUI can be displayed in response to selection of that icon (e.g. pointer or touch screen selection via touching or “clicking” of the icon, etc.) that allows the user to adjust different parameters for how the application 6 defines functions that the mobile device is to perform (e.g. volume setting for audible output generated by the mobile device, application permissions related to utilization of the mobile device's motion sensor, camera sensor, or other adjustable parameters.

Referring to FIG. 5, a GUI can be displayed in response to a user entering input to select an item to be found or have the mobile device 1 provide instructions to the user to help the user find and grasp the object. For example, the GUI of FIG. 5 can be displayed in response to a user selecting an item from the user defined selected list of items or a most recently searched for items list. The guidance GUI that is generated in response to selection of an item can provide a display of various indicia including selectable indicia that can be configured to facilitate receipt of input from a user to cause the mobile device to begin providing item finding and guidance functionality for the selected item as defined by the application 6. For example, the guidance GUI can include item found indicia and item location information that provides the user with information about what icons to select or when to select them or to provide textual output indicating that the item to be searched for has been found. The item location information that is displayed can include information that indicates where a particular item to be found can be located based on camera sensor data obtained from the mobile device as the user moved the device around a room or other area and also based on motion data or other data collected from one or more other sensors (e.g. motion sensor, such as at least one accelerometer, a GPS sensor or other device location sensor, etc.) of the mobile device while the mobile device was moved to use the camera to capture images of these locations so that the image data can be evaluated to find the item selected by the user and guidance on where the item is located can be provided to the user via the item location information displayed in the guidance GUI as well as via other output generated by the mobile device running the application 6.

The mobile device 1 running the application 6 can be configured to update the display of the guidance GUI to guide the user from detection and localization to grasping and confirmation of a desired item. All the information displayable via the guidance GUI can also be provided to the user by a speech synthesizer and output via a speaker of the mobile device 1, the guidance GUI can also display labels with relevant information such as the current instruction, contextual information, and location of the object. This can allow a user to retrieve or re-hear this information with a VoiceOver feature that can be actuated to cause the displayed information to be audibly output in case they want to be reminded of a current instruction or get some additional information output to them from the mobile device 1.

The guidance GUI can also include a display of general guidance instructions and notifications. This information can be included in the item found indicia or in the item location information indicia. Examples of the content that can be shown includes contextual content like “Please slowly move the camera in front of you. I will tell you when I find the item” or “You got it! You have ITEM. You can go back to the selection menu.” While in guiding mode, it display the current instruction such as “Left”, “Up”, “Forward”, “Backward”, “Down”, or “Right”.

The guidance GUI can be configured so that the current position of the item relative to the mobile device's current camera view is displayed. This information might also be useful for users to get an idea of the relative position of the item to them. An example of text here might be “ITEM is 2 feet away, 30 degrees left and 5 inches below the camera view.” This text can also be audibly output via a speaker 4 in addition to being displayed in the guidance GUI. Such guidance can be updated regularly in the guidance GUI to account for positional changes of the mobile device 1 and/or image captured by the camera 7 and the identified location of the item to be found.

The guidance GUI can include a guide icon, a confirm icon, an exit icon, and a restart icon to help facilitate receipt of input from a user to initiate functions that the mobile device 1 is to perform as defined by the application 6 in response to selection of the icon. For instance, selection of the guide icon can result in the mobile device providing instructions to a user to help guide the user to the found and located item. Such guidance can include audible output via a speaker or other output device in addition to haptic output and/or displayed text or visual indicia providing guidance instructions on how to find and grasp the item.

The confirm icon can be selectable to confirm the item was located and/or stop the guidance functionality being provided. The exit icon can be selectable to stop the guidance and/or exit the application. The restart icon can be selectable to return the GUI back to the item selection GUI or to restart use of the camera sensor to try and locate the item to be searched for. Selection of the icons displayed in the guidance GUI can be provided via use of an input device (e.g. pointer device, stylus, keypad) or via the user touching the touch screen display 13.

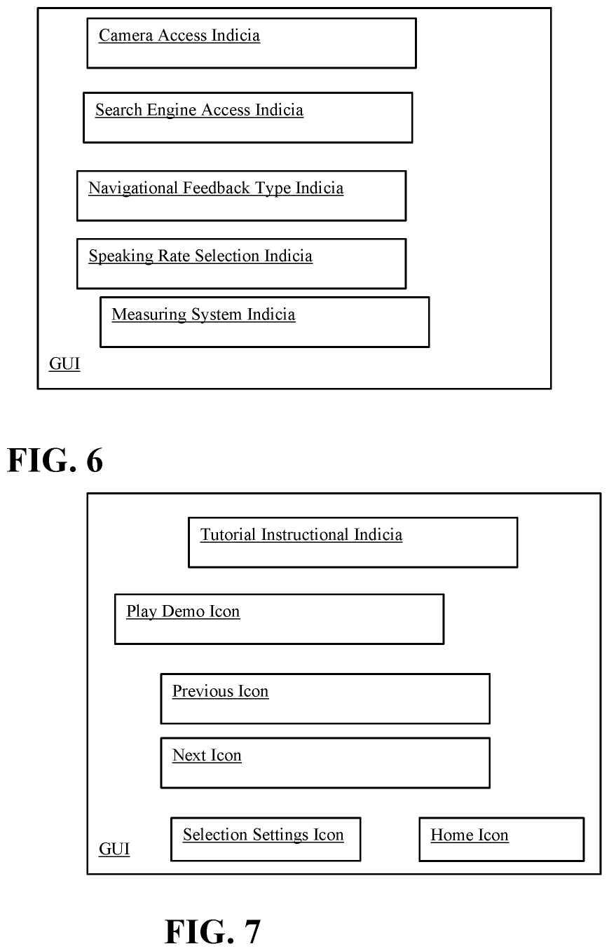

The mobile device 1 can also generate at least one user settings interface GUI, an example of which is shown in FIG. 6. The user settings GUI can be configured to permit a convenient way to allow a user to adjust functionality parameters that can affect the user's experience. The user settings GUI can include camera access indicia, search engine access indicia, navigational feedback type indicia, speaking rate selection indicia, and measuring system indicia for example. This indicia can be selectable or otherwise adjusted via a pointer device, touch screen display or other input device to adjust utilization of haptic and/or sound feedback from the mobile device when providing guidance functions when running the application 6 (e.g. actuation of some indicia can result in turning on or off haptic and sound feedback, a slider to control the speaking rate, and a submenu to choose the measuring system (i.e., metric system or imperial system can be provided in the settings GUI)). The application 6 can also be structured to define initial, default settings for such parameters and be configured to save changes the user may make so subsequent use of the application uses the settings as adjusted by the user.

Referring to FIG. 7, the mobile device 1 can also generate a tutorial interface that can be configured to provide a display of information to the user to allow the user to experiment with the mobile device 1 running the application without using the mobile device to actually find an item so the user better understands how to use the functionality provided by the application being run on the mobile device 1. The tutorial interface can be configured to simulate interactions that a user would have when guided to a real object. It can include multiple pages of content that give an overview of the functionality provided by the mobile device running the application 6 and demonstrations (e.g. video demonstrations, etc.) that can illustrate on the display 13 different stages of the guidance providable to a user to find an object and then guide the user's hand to that object.

The tutorial interface can include tutorial instruction indicia, at least one play demo icon that is selectable to play at least one demonstration video on the display, a previous icon that is selectable to show a prior page of the tutorial GUI, a next icon to illustrate a next page of the tutorial GUI. The tutorial GUI can also include the home icon and selection settings icon similarly to the item selection GUI so a user can return to a home display for the GUI or the selection GUI.

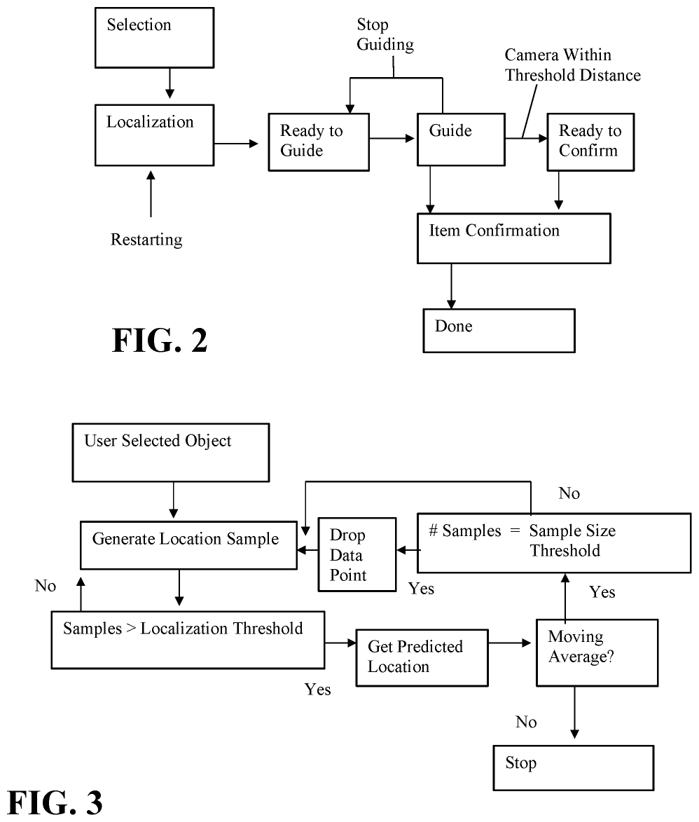

A user's utilization of the GUIs displayed by the mobile device when running the application 6 can be further appreciated from the exemplary process flow charts shown in FIGS. 2 and 3. FIG. 2 illustrates an exemplary process for providing guidance to a user to help the user find and locate an item and move his or her hand to the object to grasp the object or otherwise manipulate the object (e.g. pick the object up, etc.). This process can include a plurality of stages, which can include, for example, a selection phase, a localization phase, a guidance phase, and a confirmation phase. Embodiments of the process can also utilize other stages or substages.

For example, the process can be initiated by actuation of the application so the processor 3 of the mobile device runs the application 6. The selection GUI can subsequently be displayed to a user to facilitate the user's input of data for selection of an item to find, or locate, and subsequently direct the user towards for picking the object up or otherwise manipulating the object. For example, the selection phase can involve a user either scrolling through a list of items to select or using the search bar to filter the displayed items that can be selected in one or more of the tables displayable via the selection GUI. Once, the user enters input to select an item, the mobile device 1 will adjust the display 13 so that the guidance interface is displayed in replace of the selection interface. The guidance interface can be displayed to help facilitate operation of the localization phase of the process.

After selection is performed, localization which can occur in conjunction with the guidance interface, can be performed. During the localization phase, the mobile device can be moved by the user to use the one or more camera sensors of the mobile device to capture images of surrounding areas within a room, building, or other space to locate the item and identify its location relative to the user. For example, the mobile device 1 running the application 6 can utilize data obtained from the camera 7 and also track the localization of the item with respect to the mobile device 1. As soon as the guidance GUI starts, the mobile device 1 can provide instructions to the user to help facilitate the user's movement of the camera sensor to capture images of areas around the user for finding and locating the selected item. The mobile device can provide output to help facilitate the user's actions. For example, audible and/or text output can be provided to the user via the guidance GUI displayed on the display 13 and/or audible output from the speaker 4 to tell the user to move the camera in front of the user so that the mobile device 1 can tell the user when it has found the item. The user can also be told to move around an area or move the mobile device 1 around the user to capture images of surrounding areas. While the user moves the mobile device 1 around, the mobile device 1 can emit output (e.g. via speaker 4 and/or display 13) to remind the user that it is searching for the item (e.g. by audibly outputting “Scanning” every 5 seconds or other time period alone or in combination with displaying the term on the guidance GUI, etc.). Once the selected item and its location are detected via the camera sensor data, the mobile device can update the guidance GUI and also emit an audible notification sound to inform the user that the item was found (e.g. the mobile device can output text and/or audio to say: “ITEM found. Click the ‘Guide’ button when you are ready”).

FIG. 3 illustrates an exemplary process for performing localization based on camera sensor data. For example, the user selected object can be detected from the camera data and a location sample can then be generated. The location sample can be generated via ray casting utilizing the camera sensor data for detection of a feature point for the object and/or another type of depth detection sensor (e.g. a lidar sensor, array of lidar sensors, etc.). If there are less than a pre-selected number of localization samples, then additional localization samples will be generated via the ray casting process until there is at least the pre-selected number of samples. Once the sample threshold is reached, a predicted location of the object can be determined. This predicted location is an initial predicted location (e.g. a first predicted location) and is designed to identify a centroid of a point cloud generated by the repeated ray casting operations used to obtain the initial number of localization samples (e.g. at least 50 samples, at least 100 samples, at least 150 samples, 150 samples, 200 samples, between 50 and 500 samples, etc.). Utilization of a number of samples to generate the predicted initial location as a mean of the total number of initial localization samples was found to greatly enhance the reliability and accuracy of the predicted location determination process for the initial location prediction of the object.

The mobile device 1 running the application 6 can then update its predicted location by utilization of a moving average. For example, the initial predicted location can subsequently be compared to a moving average of the predicted location for new additional location samples that can be collected after the camera is moved as the mobile device is moved by a user to be closer to the object. The updating of the samples can be utilized to provide an updated moving predicted location at the moving average step shown in FIG. 3 to account for motion of the mobile device and camera so that at least one new location sample would be obtained for updating the predicted location based on movement of the mobile device 1. Use of the moving average feature can allow the mobile device 1 running the application 6 to update the predicted location to account for improved imaging and ray casting operations that may be obtained as the camera moves closer to the detected object. The sample size for the moving average can be set to a pre-selected moving average sample size so that the samples used to generate the predicted location accounts for the most recently collected samples within the pre-selected moving average sample size. In some embodiments, the pre-selected moving average sample size can be the same threshold of samples as the initial localization threshold number of samples. In other embodiments, these threshold numbers of samples can differ (e.g. be more or less than the pre-selected number of samples for generating the first, initial location prediction for the object). In some embodiments the pre-selected moving average sample size can be at least 50 samples, at least 100 samples, at least 150 samples, 150 samples, 200 samples, between 50 and 500 samples, or another desired sample size range. Utilization of a number of samples to update the predicted initial location via the moving averaging process was found to greatly enhance the reliability and accuracy of the predicted location determination process.

As the mobile device 1 is moved during the motion of the user to locate the target object, older samples can be discarded and more recently acquired samples obtained via the camera sensor and the ray casting operation can replace those discarded samples to update the predicted location. If the predicted location is updated to a new location, the audible and/or tactile instruction guidance provided to a user can also be updated to account for the updated predicted location.

The location of the hand of the user can also be determined by determining a location of the camera or the mobile device 1 as a proxy for the user's hand. The determination of the location of the camera or mobile device 1 can be made via sensor data of the mobile device (e.g. accelerometer data, wifi-connectivity data, etc.). The location of the camera or mobile device relative to the determined location of the object based on the camera data and mobile device sensor data can also be determined. The camera position and/or mobile device position can be updated by the mobile device via its sensor data to account for changes in camera position that may occur as the user is guided by the mobile device towards the object. This positional updating can occur independent of the camera recording a position of the user's hand. The positional adjustment relative to the object can also occur independent of whether the object is within a line of sight of the camera or is captured by a current image of a camera that may be recorded as the user moves based on instructions subsequently provided by the mobile device.

For example, the position of the object can be determined via ray casting. As another example, the object location determination can be performed using a deep learning/machine learning/artificial intelligence that directly generates the three dimensional location of the object from the camera data so that the object location is determined with respect to the camera. As yet another example, the object location can be determined utilizing feature matching to obtain the three dimensional location of the object with respect to the camera.

The determined object location can also be updated to account for subsequent motion of the user, which may provide improved data that allows the object location to be updated to be more accurate. Alternatively, the determined object location may not be updated. In either situation, the mobile device can also be configured to account for user motion based on mobile device sensor data to update the camera's location, or the user's determined location, relative to the object, based on the sensor data to update the user's position or camera's positon relative to the object for updating instructional guidance provided to the user for guiding the user to the object.

After the item localization phase is completed, the guidance phase of the process can be initiated. For example, after the user receives output from the mobile device that indicates the item was found, the user can provide input to the mobile device via the guidance GUI to initiate the guidance phase. For instance, the user can press or utilize a pointer device to select the guide icon to initiate the mobile device 1 providing navigational output to direct the user to the found item. For example, after the user selects the guide icon (e.g. actuate a displayed guide button displayed via the display 13 illustrating the guidance GUI generated by the mobile device 1, etc.), the guidance phase can be initiated as defined by the application 6 being run by the mobile device 1 (e.g. the mobile device 1 can be adjusted from a ready to guide state as shown in FIG. 2 to a guide state). Once the guide state of the mobile device is initiated, the mobile device can update the guidance GUI to identify the item's location with respect to the camera and/or mobile device 1 via text and/or graphical imaging included in the guidance GUI as well as audible output emittable from the speaker 4. For example, the mobile device can output text and/or audible output stating: “Started guidance. ITEM is x feet away, y degrees left and z inches below the camera view.” Then, the mobile device 1 can update this guidance to account for movement of the mobile device 1 and/or camera sensor to account for the changing positions to provide updated guidance feedback to the user. The guidance that is provided can include output via haptic, sound, and speech in addition to the visual data that may be provided by the indicia on the guidance GUI displayed on the display 13.

To convey that the object is in the camera view to a user, the mobile device 1 can emit a beeping sound via the speaker and/or tap depending on the user's settings. The frequency of this feedback generated by the mobile device 1 can be inversely proportional to the distance to the object. As the user's mobile device 1 gets closer to the object, the frequency of the emitted sound or haptic feedback can be increasing. As soon as the object gets out of the view, a short vibration or different sound can be triggered and the guidance GUI as well as other output can be emitted by the mobile device 1 to correct the user's hand position with speech instructions, e.g.: “up”, “down”, “forward”, “backward”, “left” or “right”.

For example, if the camera view is to the left of the object, the app will repeat “right” until the object gets in the camera view. If the camera view goes above the object, it immediately corrects the position by repeating “down”. When the object is in the camera view and within a pre-defined found object distance of the object, which can be, for example, 20 centimeters (cm), 10 cm, up to 50 cm, less than 50 cm, less than 20 cm, up to 20 cm, etc. In response to the mobile device 1 detecting that it is within the pre-defined found object distance of the object, it outputs instructions to the user to facilitate the user's grasping of the object. For example, the mobile device can provide audible and/or textual output via speaker 4 and display 13 to tell the user the item is very close to the user. For example, the output can include a display or audible output of a found statement such as, for example, “ITEM is in front of the camera. Click the ‘Confirm’ button or shake the device when you are ready”. When the user selects the confirm icon or shakes the mobile device 1 in response to this output, this can provide item confirmation and end the guidance phase of the process.

As can be appreciated from FIG. 2, there might be some instances where the user wants to stop guidance to receive detailed information about the object location. For these instances, the user can press a stop indicia that can be displayed on the guidance GUI after the guidance phase has been initiated. For example, if the user selects a displayed stop indicia (e.g. a “Stop” button shown in the guidance GUI in replace of the guide icon after the guide icon was selected), the mobile device 1 can provide output via the speaker 4 and/or display 13 to tell the user that guidance has been stopped (e.g. the user can be told: “Stopped Guidance. Please take a step back to reposition the camera. You can click the ‘Guide’ button to resume”). After the stop icon is selected, the stop icon can be replaced in the guidance GUI with the guide icon so the user can re-select the guide icon to restart the guidance phase. For instance, as soon as the user presses the guide icon shown in the guidance GUI again, the mobile device 1 can resume its guidance function and resume providing navigational guidance instructions to the user to guide the user to the object. For example, the mobile device can provide output to tell the user something like: “Started guidance. ITEM is x feet away, x degrees left and x inches below the camera view” etc. as can be appreciated from the above as well as elsewhere herein.

As can be appreciated from the above as well as elsewhere herein, the mobile device 1 can be configured to inform the user when the item is behind the mobile device and/or the camera. This could occur in the event (1) the user is pointing the mobile device 1 in the opposite direction to the object or (2) the user's phone gets behind the object. For condition (1), the mobile device 1 can be configured to provide output to inform the user that the item is behind the camera (e.g. the mobile device can output text and/or audio stating: “It appears that the item is behind the camera”. For the second situation (2), the mobile device can be configured to respond to the detected condition by providing output indicating the item is behind the user (e.g. visual and/or audible output can be emitted that says: “It appears that the item is behind the camera. Please take a step back”. This particular situation can arise in various situations, such as when the object is in or on a low surface and the hand of the user inadvertently went behind the object.

Once the user is notified that the item is hand-reachable and in front of the mobile device 1 or camera view of the mobile device 1, the confirmation phase can be initiated. For example, the user can double check that the grasped item is correct by selecting the confirm icon displayed in the guidance GUI (e.g. clicking the “Confirm” button or shaking the device). Such confirmation input can cause the mobile device to respond by emitting output to the user to allow the mobile device to confirm the item has been found and grasped by the user. For example, output can be emitted via a speaker 4 and/or the guidance GUI that says: “Please move the item in front of the camera”. Then, the mobile device can attempt to recognize the item via the camera sensor data of the item placed in front of the camera. After the mobile device 1 recognizes the item, it can provide item confirmation output to the user to end the process. For example, the mobile device can output audio and/or visual output that tells the user “You got it! You have ITEM. You can go back to the selection menu”. In response to such output, a user can shake the device to trigger the completion of the process and have the selection GUI displayed and select an icon or other indicia of the guidance GUI to complete the process and have the display 13 updated to illustrate the item selection GUI.

The guidance GUI can also be configured to permit the user to trigger item confirmation at any point. This can be used for example if the user feels that they can grasp the item before the app notifies it is already close. In such a situation, item confirmation can be initiated in response to the user selecting the confirmation icon on the guidance GUI, for example.

The application 6 can include various different components and can include a 3D Object Detection with Tracking, and Guidance Library. For both components ARKit, Apple's framework for augmented reality applications, can be utilized to prepare the coding for these algorithms and can utilize a technique called visual-inertial odometry (VIO) to understand where the mobile device 1 is relative to the world around it and exposes conveniences that simplify the development of augmented reality solutions. Use of such functions can make developing embodiments of the application easier for defining processes the mobile device 1 is to perform for detecting and tracking the position of objects with respect to device's camera frame. Of course, other embodiments can utilize other types of libraries based on other frameworks provided by other software providers or utilize a fully unique, custom designed software solution for coding of the application to provide this type of functionality.

The application 6 can be structured to utilize ARKit so the mobile device 1 can recognize visually salient features from the scene image captured by the camera 7. These salient features can be referred to as feature points. The mobile device 1 can track differences in the positions of those points across frames of the camera sensor data as the device is moved around by the user and can combine them with inertial measurements obtained by at least one motion sensor (e.g. accelerometer) of the mobile device. The processing of this data can result in the mobile device providing an estimate of the position and orientation of the device's camera with respect to the world around it. In other embodiments, similar processing can be defined in the application for use with other software coding tools such as Vuforia and ARCore.

The mobile device 1 can be configured via the code of the application 6 that can be run by its processor 3 to record feature points of a real-world object and use that data to detect the object in the user's environment from the camera sensor data obtained from the camera of the mobile device 1. This feature can be provided by use of the ARKit or Vuforia developer kits in some embodiments of the application 6. This feature can be provided by use of another developer kit or by customized software cording in other embodiments.

The application 6 can be defined via coding so that the mobile device 1 running the application 6 is able to record feature points from the camera sensor data and save that data in an .arobject file or other type of data store 8 that can be stored in the memory 5. To generate the .arobject file, a utility app provided in Apple's documentation can be utilized for mobile devices that utilize an iOS operating software. Other embodiments can utilize a different file type for storage of such data that is supported by the operating software of that mobile device 1.

The mobile device 1 can be configured via the code of the application 6 that is being run by the processor 3 so that the mobile device can extracts spatial mapping data of the environment based on the camera sensor data. The device can utilize the same process used to track the world around the device's camera to perform this extraction of spatial mapping. then, the device can slice the portion of the mapping data that corresponds to the desired object and encode that information into a reference object (e.g. the reference object can be called an ARRreference Object in the code or have another object name). This reference object that is defined can then be used to create the data store 8 that records the feature points from the camera sensor data (e.g. the above noted .arobject file or similar file).

After such a data store 8 is obtained for every object of a list of objects, these files can be embedded in the application 6. The AR session can be configured to use these files to perform 3D object detection from the camera sensor data received during the localization phase.. Every time an object is detected, an anchor can be added to the session to flag that detected object. The included anchor can be a defined object representing the position and orientation of a point of interest in the real-world that is added to the received camera sensor data. Using a reference to that anchor, the mobile device 1 can then track the object across video frames of the camera sensor data.

The application 6 can be coded to facilitate use of a guidance library to help define instructions for the guidance phase of the process to be performed by the mobile device. For example, to provide horizontal direction guidance, e.g. left, right, forward, or behind guidance, the following exemplary horizontal guidance algorithm can be utilized:
1. Get the transform from the anchor representing the object and the transform from the camera sensor data. Both transforms can be provided by utilization of ARKit or similar software tool or via a customized tool.
2. Extract the object position from both transforms while setting the y value to 0. The position of these two transform vectors are with respect to the World Origin, which the basis of the AR world coordinate space. By default, the World Origin is based on the initial position and orientation the device's camera at the beginning of an AR session.
3. Get the normal of the anchor with respect to the camera position and define this normal of the anchor as a normal vector object (e.g. call this vector normal AnchorFromCamera or other type of object name).
4. Create a new transform front of the camera and define that new transform front of the object as with a new object name (e.g. Call this transform newPointTransform or use another object name for this).
5. Extract the position newPointTransform while setting the y value to 0.
6. Get the normal of the new point position of the camera front with respect to the camera position and define this object (e.g. call this result normalNewPointFromCamera or use another name for this object).
7. Obtain the dot product between these normal values (e.g. obtain the dot product between the normalNewPointFromCamera and the normalAnchorFromCamera).
8. Get the angle between the new point position of the camera and the object anchor by taking the arccosine of the dot product from step 7. This will give the magnitude of the angle, a value between 0 and 180.
9. Get the cross product between the normal values (e.g. normalNewPointFromCamera and the normalAnchorFromCamera values). This can allow the mobile device to distinguish right from left. If the y value of the normal position is negative and between 0 and 120 degrees, then the camera is looking to the right of the object and the user needs to be informed to move to the left. If the y value of the normal position is positive and between 0 and 120 degrees, the camera is looking to the left of the object and the user need to be told to move to the right. If the absolute value of the positive or negative angle is greater than 120 (e.g. is −120°-180° or 120°-180°), then it means that the object is behind the camera and the user is to be informed that the object is behind the camera or the mobile device 1.

A different algorithm can be utilized to obtain the vertical directional guidance (e.g. up or down). Instead of considering an angle between a vector projected in front of the camera and another to the object as utilized in the exemplary horizontal directional guidance algorithm discussed above, a height between the camera and the object can be utilized. If the y difference between the camera position and the object is positive, then the camera (and mobile device 1) can be above the object and audible instructions and/or tactile instructions output by the mobile device (e.g. via speaker, vibration mechanism, a peripheral device, etc.) can instruct the user to move the camera downwardly. If the y difference between the camera position and the object is negative, the camera (and mobile device 1) can be below the object and audible instructions and/or tactile instructions output via the mobile device can instruct the user to move the camera upwardly.

To show the distance information between the camera view and the object, we considered the distance between them while ignoring the height difference. So, we extracted the position from the anchor, and camera transforms while ignoring the “y” value. Then, the application can be defined so that the camera position is subtracted from the anchor position, and the magnitude is subsequently extracted.

The horizontal and vertical positioning of the camera relative to the object can be repeated as the mobile device 1 is moved by the user to determine new locations of the camera relative to the object so updated audible instructions can be output by the mobile device 1 to guide the user closer to the object.

Embodiments of the mobile device 1 can be configured so that the application 6 is defined such that the haptic and sound feedback can be synchronized. The sound feedback (e.g. sound emitted by speaker 4) can be generated using a beeping sound at a pre-selected beeping frequency (e.g. 440 hertz, 500 hertz, 400 hertz, etc.). The pace of the sound emission can be varied within a pre-selected beeping frequency range (e.g. between 60 beeps per minute (bpm) to 330 bpm, between 20 bpm and 350 bpm, etc.). The value for the beeping frequency can be determined by dividing 90 by the distance the camera is from the object in meters. This value can be obtained empirically. Additionally, the application can be defined so that the mobile device's sound and tapping feedback is only delivered when the object is inside the viewing frustum of the camera (e.g. within the camera's sensor data).

To permit adjustment of user settings, an operating system bundle can be utilized for code of the application. For example, for an iOS operating system, an iOS settings bundle can be utilized to facilitate the settings GUI and adjustment of the settings.

It should be appreciated that other embodiments can utilize other mechanisms for determining the location of an object or the location of the camera, which can be a proxy location for the hand of the user. For example, mobile device sensor data can be utilized to determine the location of the hand of the user via the location of the mobile device and/or the camera and that sensor data can be used to update the determined position of the mobile device and/or camera as the user moves toward the object based on the audible and/or tactile instructions provided by the mobile device. As another example, the location of the object can be determined via use of an AI trained object detection algorithm or function. For instance, the location of the object can be determined directly from locating the object within the camera data and that determined position can be utilized as the determined position of the object. The mobile device's position can then be determined and updated in relation to this determined position of the object.

It should be understood that the object can be any type of object. For example, the object can be an animal (e.g. a pet, a child, etc.), a toy, a vehicle, a device (e.g. a remote control, a camera, a box, a can, a vessel, a cup, a dish, silverware, a phone, a light, a light switch, a door, etc.).

### Examples

We conducted studies to evaluate embodiments of our mobile device 1 and application 6 that is downloadable into the memory of a mobile device and executable by a processor of the mobile device 1 to configure the mobile device with the functionality defined by the application so that the mobile device can perform a method defined by the code of the application. We conducted two different user studies with an embodiment of our experimental design to evaluate the accuracy and effectiveness of our application-prototype at finding a target object and guiding the user's hand to it, in addition to, get feedback about the performance and overall experience. For the preliminary evaluation and the main user study refinement, we carried out a pilot study with blind-folded sighted people in the controlled laboratory setting. The main study with people with visual impairments was conducted in their home through a virtual setting using a video chat mediated platform, Zoom. We revised the study design and took a novel approach for overcoming the challenges of not being able to pursue face to face interaction-based human subject research due to the COVID-19 pandemic. This revised research method enabled us to conduct the confidential, experimental user study with the participants with visual impairments in their home space, and it is a secondary contribution to the accessibility research community. The following sections present the details of this conducted experimental study of an embodiment of our mobile device 1 and application 6 configured to utilize an embodiment of our method of guiding a user to an object so the user can pick up or otherwise manually manipulate the found object.

### First Pilot Study

In a first pilot study, we conducted an iterative design piloting with six blindfolded people in a controlled lab setting to empirically identify features that were missing or could be improved. The pilot study was a confidential study conducted in a lab setting. The study included a setting of shelves and objects on shelves. Blindfolded participants utilized an embodiment of the mobile device 1 running an embodiment of the application to be guided to an object of interest on the shelves (e.g. a box of cereal, a can of food, etc.)

There were two significant benefits of the pilot study: we were able to identify additional features need to be added, and potential sources of confusion that can be addressed by embodiments of the mobile device 1 and application 6. The major refinements resulting from the pilot study evaluation included: (1) provision of regular, continuous status updates during the scanning phase in both localization and confirming stages of the process; (2) provision of the relative distance and degree from the camera of the mobile device to the target-object in order to help the user's orientation; (3) revision of the instructions communicated to the user via the mobile device 1 that tells the user to place the item in a favorable location for confirmation; (4) adding a pleasant and clear notification sound when the item is close to the device to increase the certainty that the object is at a reachable distance; and (5) adding a tutorial via the tutorial GUI to help the user understand how to use the application properly. The above adjustments were made based on the results of the study to improve the usability of embodiments of the mobile device 1 and application 6 and address unexpected issues that can affect successful utilization of the device and application for some end users.

### Second Main Study

A second confidential study was subsequently conducted to adjust the environment for the conducted study to evaluate the robustness of how usable embodiments of the mobile device 1 and application 6 could be. The setting for this second study was changed from the laboratory to the home of the participants of the study to establish a virtual field experimental study mediated by a video chat platform. The study was revised and designed to be able to run the remote experiment with participants with visual impairments via video chat that mediated and enabled operation and observation of the participants during their use of the mobile device running an embodiment of the application during the study. The scenario of the task was revised for the home space with the scenario modified from finding products and picking them up from the grocery store shelf to finding purchased products and picking them up in the home environment.

In order to make the home as a controlled laboratory, we prepared a study kit that included one iPhone 11 mobile phone with an embodiment of the application installed on the mobile phone and three product items (box of cereal, can of Lipton tea mix, and a box of fruit and grain bars) and sent the kit to each participant's home. Beforehand, we communicated with the participants and obtained their agreements and consents for the at-home lab study setup on the following items—1) receipt of the study kit and its contents and their return of the iPhone; 2) need of coordination for study setting through Zoom video connection; 3) possibility and need of two devices setup at home during the Zoom video session for having two video feed views from different angles; 4) conduct of Zoom video chat study, a researcher's observing the participant's trials through video feed, and video recording of full session of the trials.

Once we received the agreements from the participants, we sent out the study kit a few days ahead of the scheduled date for the participant to have time to get familiar with the iPhone 11 and to learn about the embodiment of application through the tutorials put on the application and usable via the tutorial GUI. A virtual meeting created with the meeting ID and password for joining the meeting was sent to the participants along with explanation of need of using the meeting ID and password to help ensure the conducted study was conducted confidentially.

It was important to observe the participants' performance of the trials through two different camera views, a wide-angle view and close-up view in front of the participant. It becomes even more critical for our study on the mobile device-based hand guidance because the interaction of the hand with the smartphone and how the participants moved their hand and reached out to a target product can occur in a relatively small space. Thus, we asked the participants to have two devices available and set them in different locations where they can provide both a side view and a front view. The side view showed the wide scene with a whole setting of the study and the whole body and hand posture and movement can be observed. The front view showed a view of front of the participant and the three product items. This view clearly showed the process of hand movement and touching the target item in the very last phase of guidance. These two scene settings complemented each other and reduced the possible chances of missing or losing the important moment of trial process and allowed for observation of the user interaction akin to a face-to-face environment, albeit remotely.

This virtual video chat mediated at-home lab study with two video feeds and with the collaborative setup of the participant with visual impairments allowed us to conduct the confidential, remote experimental user study with people with visual impairments and to provide the participants with visual impairments with similar experience of the lab study originally planned for the end user validation.

A total of ten participants (five males and five females) were recruited from multiple cities through a local chapter of National Federation of the Blind (NFB), contact of previous study participant, and snowballing sampling method. Their ages ranged from 22 years to 45 years old. The participant table (Table 1) lists demographic and personal details for each participant. All of our participants are visually impaired (see Table 1) and were users of iPhone with Voiceover. All reported that they have normal hearing except for one participant who uses a hearing aid. None of the participants had a problem in sensing haptic feedback on their hand. They had experience with haptic sensation mostly through braille and cane use, also with vibrations on smart phones and other assistive devices such as BlindSquare. Also, none of the participants have any arm and hand motor impairments. They participated in the study on voluntary basis without any compensation.

TABLE 1
Participant Demographics

| | | | Level of Visual | Onset of | |
|---|---|---|---|---|---|
| Participant | Sex | Age | Impairment | vision loss | Hearing difficulty |
| P1 | M | 35 | No light perception, total | 20 years | None |
| | | | blindness | old | |
| P2 | F | 44 | Totally blind, a little bit | From birth | None |
| | | | of light perception, | | |
| | | | retinopathy of | | |
| | | | prematurity | | |
| P3 | F | 37 | Glaucoma; legally blind | From birth | None |
| | | | (can see contour and | | |
| | | | shape) | | |
| P4 | M | 23 | Totally blind, glaucoma | 18 years | Hearing impairment |
| | | | on cornea | old | |
| P5 | F | 22 | Total blindness, little bit | 5 years old | None |
| | | | of light perception. | | |
| | | | Juvenile astronomy. | | |
| P6 | F | 22 | Total blindness | From birth | None |
| P7 | M | 29 | Total blindness. | 10 years | None |
| | | | congenital low vision | old | |
| | | | due to Glaucoma | | |
| P8 | M | 45 | Total blindness. | 10 years | None |
| | | | congenital low vision | old | |
| | | | due to Glaucoma | | |
| P9 | F | 44 | No light perception; total | From birth | None |
| | | | blindness | | |
| P10 | M | 40 | Total blindness | From birth | None |

The task each participant performed in this study involved finding each of the three product items placed on a kitchen counter, a desk, or a dining table and reaching out/picking up each item using the three options of navigation feedback types (sound, haptic, or both sound and haptic on) with speech guidance. The study session including the performance of experiment and interview took one and half hour to two hours. Each participant was asked to perform a total of nine trials. The location of the products was switched in a random fashion for each set of 3 trials. Two participants were helped by a family member to change the locations and the rest of participants did the change by themselves. Then the participant was asked to walk approximately 5 foot away from the place of the product location. We made sure that participant's switching the location of the products themselves did not affect their performance by running a quick trial with a friend of the researcher who is a totally blind. The order of trials was counter-balanced for reducing the sequence effect.

We collected two types of data—One is video recordings of the video sessions of the participants' performing tasks and the other is audio recordings of the post-study interviews. The researcher connected with the participant on the video conference platform using a video recording software OBS (Open Broadcaster Software) to record the video sessions. OBS recording was chosen to remedy the problems caused by the automatic speaker focused screen view of the built-in recording of the video platform that was used, which could cut out the parts of the trial of the video recorded for the case of the researcher talking. Besides, the view of the muted speaker is not recorded for the same reason, but this setting is necessary to remove the howling noise when two devices are adjacent each other. Once the trials were finished, the semi-structured interviews were conducted right after. The interview questions were developed with focus on the helpfulness and usefulness of the guidance processes, types of information provided, and types of feedback provided with the mobile device. From the video recording, we collected the performance data such as measuring time of the each phase of the guidance and counting the number of failures and the observation data on user interaction with the smart phone, how the guidance as followed, and for acquiring the pose of the user body and hand. Also, we were able to obtain the immediate feedback from the participant on specific features from particular moments of the process from the video recordings and these data were documented.

At the beginning of the video conference connection, the researcher obtained the verbal consent from the participant about the study participation and video/audio recording of the Zoom session of their performing of the trials. The consent in verbal responses were all recorded. Then with the participant and/or a family member of the participant, the researcher discussed and setup the experimental setting with figuring out the best possible places and locations for the three items and two devices to be located. The final setup was made through numerous times of adjusting and fixing. After the settings were complete, the training was followed. It started with questions and answers from the tutorial experience, a brief description of the how the embodiment of application on the participant's mobile phone was to provide guidance from the scanning phase to the confirmation phase, the learning of mobile phone usage, and actual trials to provide real experience with clarifying confusion on how they use certain features of the guidance. Then the actual trials were performed and the participant interview was followed after.

### Results of Second Study

From the video chat mediated user evaluation, we collected quantitative and qualitative data and evaluated the effectiveness of the hand guidance provided with the capability of calibration and localization and also the assistive experience of the application for finding and obtaining the target object that the people with visual impairments had with their self-report feedback. We describe the details of these results below.

For evaluating the performance and the effectiveness of each feedback mode, one researcher of the team measured the time each participant took to finish the trials from watching the video. For the accurate analysis, we took measurement of each phase of the guidance separately—scanning for finding the target->guiding->scanning for confirmation. We also tracked the following errors: (1) number of times an incorrect item was retrieved, (2) number of trials that were not completed and stopped by the participants' requests in the middle of the trial; and (3) number of times of confirmation undone either no confirmation activated by the participants or stopped due to the lengthy scanning process.

We performed one way and two way repeated ANOVA test on each item and feedback type. The results did not show sequencing effect. Some participants showed improvements on their performances in their later trials, however the different was not statistically significant. We observed a consistency in within subject data analysis result on the performance with the different type of feedback and items in the shape and size.

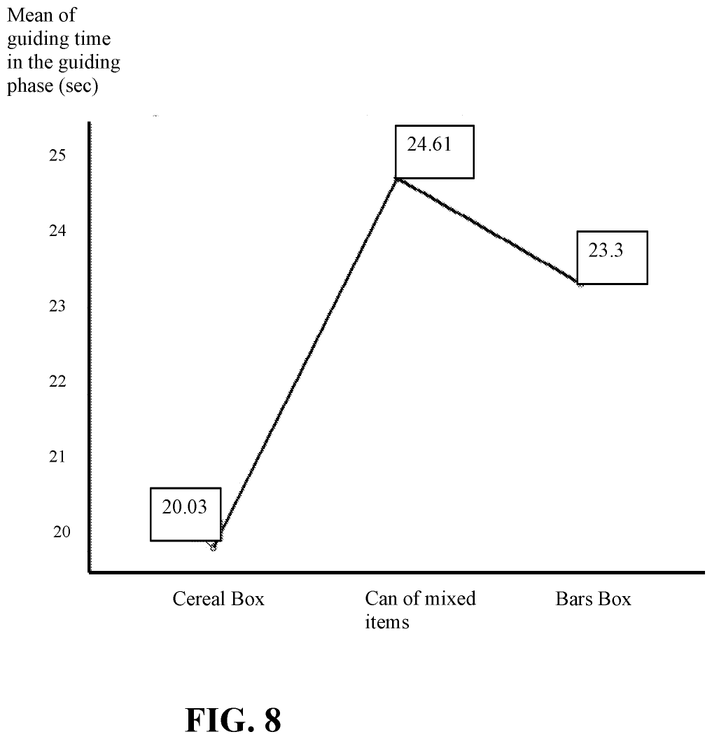

The three items (a box of cereal, a can of Lipton tea mix, and a small box of fruit and grain bars) showed a difference in the performance during the guiding phase where the participant utilized the feedback and followed the instruction. Each item type had at least 30 trials (10 participants×3 trials of each item) and some items had additional trials due to retrials or more trials due to the decision of the participant. For the performance time analysis, we did not include time it takes in the scanning phase since guidance does not occur until after object detection. We only included successful trials, however two data points were missing—one due to occlusion from video footage and another since the participant did not want to perform a retrial with the can of tea mix. We averaged the time of all trials to indicate task completion time for each item (See Table 2 below). FIG. 8 also illustrates these results.

TABLE 2
Comparison of Performance for Items

| Item Type | Mean | Standard Deviation | Trials |
|---|---|---|---|
| Cereal box | 20.03 seconds | 20.10 | 30 |
| Tea mix can | 24.60 seconds | 30.15 | 28 |
| Fruit bars box | 22.30 seconds | 17.23 | 30 |

We also performed a one-way analysis of variance (ANOVA) to compare performance across each feedback mode and found that the difference was statistically significant for the types of feedback (sound, haptic, or both sound and haptic). The number of trials and missing data are the same as the analysis by item noted above (e.g. Table 2 and FIG. 8 results). The analysis shows that the participants performed best with the sound only feedback. The sound and haptic combination feedback showed similar performance time with the sound only feedback and the haptic feedback showed relatively slow performance time (see Table 3).

TABLE 3
Performance Per Feedback Type

| FeedbackType | Mean | Standard Deviation | Trials |
|---|---|---|---|
| Sound only | 19.61 seconds | 11.09 | 30 |
| Haptic Only | 28.11 seconds | 37.16 | 28 |
| Both sound and | 20.60 seconds | 12.29 | 30 |
| haptic | | | |

We considered the task failed if the wrong item was reached out or the task was incomplete and the number of incidence of these cases were tracked. The task doesn't include the confirmation phase since we implemented it for an additional phase for assuring about the item retrieval. There were total of 2 failed cases out of more than total of 90 trials. Both P1 and P4 reached out to the wrong item when both used haptic only mode and the target item was the can of the tea mix. The total result indicates high accuracy for embodiments of our application, mobile device, and method helping a user find an object and guiding the user to acquire it.

We also tracked the number of times the confirmation phase was skipped or stopped by the participants due to excessive delay in feedback. We had 18 such occurrences of incomplete confirmation cases. Specifically, there were 3, 7, and 8 occurrences with the box of cereal, a can of tea mix, and a box of fruit and grain bars (which have a smaller box compared to the box of cereal) respectively.

After the trials, a semi-structured interview was conducted to learn about the participants' overall experience of the guidance provided, divided into three phases (localization, guidance, and confirming), and the usefulness of different components of the guiding interface provided by the mobile device 1 running the application 6. We evaluated the usefulness and helpfulness of the following components of the guiding interface: a) location information with measures for distance and direction, b) different types of feedback modes, c) status update and error recovery features, and d) confirmation process. Also, all of our participants with visual impairments provided rich open-ended feedback about the assistive experience that they had with the mobile device running the application in regards to the guidance, interaction interface, and mobile device-based application.

For example, participants provided comments about the guiding phase, the interval between the start of navigation to the grasping of the object. They provided comments on how helpful and useful the application was. Below are some of the comments from the participants.
P2—“because it's pretty quick, that's good. Because people don't want to spend too long to find something.”
P1—“it was responsive that it finds the items pretty quickly . . . how detailed and specific is . . . ”
P9—“it would correct you, like “okay, you're too far to the left, go to the right.” So, it does self-correct. Or it corrects you when you put it that way.”
   P6—“good combination because you've got the first direction, and the guiding, which is, it's two feet, you know, five inches to the left.”
   P4—“how far away it is, and what direction to kind of lean towards. And the secondary, I think, part of the directions, is the haptic or the sound. Because that tells you how, you know, you're getting closer. So, I think you need both.”

The participant feedback confirmed that embodiments of our application 6, mobile device 1, and embodiments of our method defined by code of the application 6 could provide reliable guidance that was easy to use and helpful.

The location information was found to be helpful and useful, especially at the beginning of the guiding phase. The information helped most participants to have a good guesstimate of where the target is and where to move. P5, P9, and P10 said “they were extremely helpful”; “I love this”; and “it's handy, I think that's useful”, respectively. P10 elaborated on how helpful the information was: “Rather than being surprised by direction, being like which side again? It gives enough tail that you can snap yourself to attention as supposed to think your phone is jibber jabbering.” P8 shared how he used the information in his trials: “When it said it was like 36 inches away and 14 degrees to the right, I knew that I needed to angle the phone a little bit to the right, to get it flat and lined up.”

In addition, some participants expressed concern on effectiveness about the degree information provided by the mobile device. P1 said “ . . . the degrees. That was little bit wishy-washy, like okay, degrees, what do they mean, like degree of tilt?. . . .” P2 said “that part may not be as helpful, because people don't—a lot of people aren't gonna have an accurate sense of degrees.” As can be appreciated from the above, the output provided by the mobile device can include other information in addition to or as an alternative to identifying the degrees to which a camera should be turned (e.g. move to the right, move to the left), and this can help alleviate this type of concern some participants had with the instructions' perceived lack of clarity.

The mobile device was configured during the studies so that it would also provide speech directions. In addition, it provided three types of feedback modes to choose from—sound only, haptic only, and combination of both sound and haptic. We were, in particular, interested in finding out the effectiveness and preferences of these three types of feedback, which the mobile device 1 provided for the task of finding an object and grabbing it when running the code of the application 6.

All participants reported that both individual or combined feedback were similarly helpful and effective in regards to understanding how close or how far away the target is from the phone and knowing that the target is in their camera view. Complementing the speech instruction for directions with other feedback types helps provide a perception that the guidance output via the mobile device 1 is responsive and adequate. Another common theme among all the participants were practicality and utility of haptic type for the situation and for someone who has both visual and hearing issues. Their experience and preference on each type are described in the following sections.

Two out of the ten participants said they preferred and would choose the sound only option. P6 liked the sound feedback over the haptic one because she is more aware of the auditory feedback than haptic feedback. She also mentioned that she got more notification from her smartphone with sound than vibration notification. P6 provided this comment with regard to the effectiveness. “Sound is more defined and haptic cannot be loud.” She said she liked the speech feedback (left, left, right, right) very much. Her performance data from her trials consistently match with her preference and clearly shows that sound feedback works better for her performance. Her averaged time with sound and haptic were 20.3 sec and 66.3 sec respectively. Sound feedback is also preferred by P10 and he provided the reason from the consideration of need to more cautiously hold the phone to receive the accurate feedback. He said “rather picking comfortable grip in and listen for a ding ding ding ding ding ding . . . you don't have to worry about your phone jumping out your hand at some points.”

Among the ten participants, three claimed the haptic feedback option as their preference as opposed to the sound option. The main theme commonly appeared from their discourse was a cognitive overload caused by other auditory information overload because hearing is their main channel for receiving information. P8 said “I get tired of listening to—constantly having to listen . . . like speech feedback telling you left and right is okay, but constantly listening to the beeping is annoying.” P3 also made similar comments: “Extra second needed to think about what happened . . . haptic is easy.” P2 elaborated on this aspect and said “haptic gives you more feedback and more consistent . . . because the haptic you can also hear too.” In contrary, she made following points regarding the sound feedback. “The sound, just the sound doesn't . . . doesn't give you constant information, sound is affected by a lot of factors . . . surrounding noise, volume, other types of audio info.”

Concurrent sound and haptic feedback was the most preferred feedback of the participants. Five out of ten participants expressed their favor on the combination of the both with respect to the benefit of not only having more information to use but also using alternative (backup) for the case of one sensory channel needs to be used for other interaction (e.g., talking with a friend). P1 and P5 emphasized the aspect of reinforcement effect that two types of information created. P1 said “Both of them combined maximized the potential to get the object.” P5 also said “I always like great amount info as possible . . . I found it super helpful.” P9 said “because you get it both ways, so you know if I'm not exactly paying attention. You're just not quite paying attention, like if you were on the phone talking to somebody.” Compared to the participants who prefer one type over the other and showed significant difference in a performance, the performance of those participants who liked combination better does not show the significant gaps but similar level with each of three types of feedback.

Most of participants did not find the confirmation phase useful but confusing for the following reasons. First, they did not need of the confirmation of the products in our experiment that involved a limited set of three distinctive products by shape and size. P9 said “three totally different sizes and shapes, I didn't have to use it as much.” Second, it takes a while to finish the confirmation process because it involves a scanning process and requires the user's effort of aligning and making good amount of space between the camera and the object for the system to be able to identify the target. P5 implied that the process was long with her comment: “Quick confirm preferred but it was ok.” Lastly, a gesture input interaction with shaking the phone feature without the feedback was not intuitive but created extra step. P8 said “it doesn't seem like a natural thing to do if you're using your camera to find something to shake your phone.” P4 added “there wasn't a feedback that it was changing to confirming, so like, when you're starting the guide, you hit guide, and so my instinct would have been to confirm, like hit the button and then confirm, the shaking is different for me, because I didn't hear it say confirming or you know, anything like that. So, there wasn't any audible feedback on that part.”

This feedback helped show that embodiments of our process does not require use of item confirmation to be utilized to find an object or facilitate use grasping of that object. After the object is found, the user can simply stop the guidance, close the application running on the mobile device 1, or utilize the GUI to return to the selection GUI to select a new target item to find.

The result of the evaluation of the feedback shows that the sound only feedback (speech+sound) was often the most effective as compared to the other two options—haptic only (speech+haptic) and combination of the two (speech+sound+haptic) for the user with visual impairments to find a target object and reaching out to it with the mobile device based assistance. Only two of the ten participants preferred the sound only to other feedback options. It is interesting that the participants' performance got slowed with the haptic only feedback even if many participants perceived this as an easy and quick cue that does not require more information processing effort. This might imply that information delivery with different types of modality (haptic+speech) puts more cognitive load than overload of information with the same types (sound+speech). Also, it is a good design implication that points out the importance of considerations in possible secondary interactions with surroundings. The feedback from the studies overall shows that providing user settings to allow a user to adjust some of the ways in which the mobile device 1 can provide output to the user for navigational guidance to an object can be useful to account for different users' preferences.

The embodiment of the mobile device 1 running the embodiment of the application 6 in our studies utilized two different types of auditory representation (sound and speech) for two different types of information—sound for distance cue and speech for directional cue. Moreover, the information was not provided at the same time but at different times in a continuous fashion. This way of presenting information might reduce the cognitive overload and even facilitate the information processing even if both are auditory representation. This might be a reason that participants described the guidance as responsive, detailed, specific, even powerful.

All of the participants showed predilection for the mobile device based assistive technology even if the mobile device usually needs to be held and occupies one hand. The study results showed that the mobile device based assistive application was mostly welcomed and favored, and people with visual impairments were willing to work around inconveniences associated with holding the mobile device in a hand of the user when using the device running the application.

When P8 was asked if there is anything else that could be used instead of smartphone, he answered “I don't think there's anything other than a smartphone you could use.” The numerous existing examples of smartphone based assistive technology clearly supports this trend. The main reasons for this trend told by the participants are portability and no stigmatism. Their ability to use the main stream technology that sighted people use and avoiding specialized technology, which could bring uncomfortable attention plays a major role that makes smartphone app as a go-to option. P6 said “so many people use it now.” However, at the same time, inconvenience and challenges were brought up and how they limit the usage was revealed from the interviews. Some participants suggested ideas of using wearables like a wristwatch, a bracelet, and smart glasses or any pair up with a phone. P9 said “ . . . if there was something that had a camera pointed forward over your wrist, then you could just have it like that, that might be useful.” This feedback helps confirm the embodiments of the mobile device can provide useful functionality when embodied as a tablet, smart watch or other type of mobile computer device.

In our user study, we evaluated the functionality of the mobile device 1 running the application 6 as an assistive technology for helping people with visual impairments to find an object and picking it up. In our evaluation, we used three grocery products as a target item with a scenario of identifying purchased items at home. With a high accuracy in finding a targeted item and guiding the hand to the item wanted, our participants expressed their excitement with a possibility of usages in other situations and shared those scenarios/cases that they envision. The most common task they mentioned that they want to use it for was identifying similar objects such as clothes, medication, beauty and healthy products, cleaning products, and similar shape of products. P2 said “anything that can help you find something is good.” P1 said: “I would say grocery shopping, clothes shopping, helping to locate objects around the house. I don't know if there could be a library for like keys or shoes, like if you've lost something or misplaced an object like a cup. You don't know what you did with your cup.” “This is actually telling you that an object is there and guiding you to that object, so that would really expand the usability and functionality of an app like this. A lot of apps tell you what's around, but they don't guide you to what's around.”

Embodiments can utilize feature-point-scans preloaded into the application (e.g. stored as data stores 8). Such features can be appropriate as a grocery store application in the stage of identifying the product and acquiring it or to find known items around the house.

Embodiments can utilize a machine learning model to perform 3D object detection of generic objects (e.g. generic objects like a shoe, apple, and bottle). The modular design of embodiments of the application can allow the current object detection module to be upgraded with an improved version via an application update that may be delivered via remote server (e.g. an application store server).

Also, embodiments of the mobile device 1 can utilize other sensors (e.g. depth-sensing technologies such as LiDAR scanners and time-of-flight-cameras). Such sensors can be utilized to provide additional detailed instructions to help guide a user to an object and find that object so that shorter response times and more complex scenarios can be quickly and effectively addressed.

Embodiments of the application 6 can also be designed and structured so that people with visual impairments can train the application 6 run by the mobile device 1 to detect personal objects. The mobile device 1 can be configured to utilize a conversational interface powered by natural language processing technology to help improve the clarity and reliability of output instructions and receipt of input via a microphone or other input device as well.

Embodiments of the application 6 and mobile device 1 can be configured so that the mobile device does not use external sensors and does not need an internet or wireless connection. For instance, a network connection is not necessary for the application to be run on the mobile device to perform an embodiment of our method or otherwise provide localization and guidance to a user. Further, the mobile device does not have to be connected to any peripheral sensors to provide this functionality.

It should therefore be appreciated that embodiments of our mobile computer device (e.g. a smart phone, a tablet, a smart watch, etc.), a non-transitory computer readable medium, and a hand guidance system, and method of providing hand guidance can be adapted to meet a particular set of design criteria. For instance, the particular type of sensors, camera, processor, or other hardware can be adjusted to meet a particular set of design criteria. As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain present preferred embodiments of a mobile computer device, a non-transitory computer readable medium, and a hand guidance system, as well as embodiments of methods for making and using the same have been shown and described above, it is to be distinctly understood that the invention is not limited thereto but may be otherwise variously embodied and practiced within the scope of the following claims.

1. A mobile device comprising:
a processor connected to a non-transitory computer readable medium having an application stored thereon, the application defining a method that is performed when the processor runs the application, the method comprising:
responding to input selecting an item to be found by utilizing at least one camera of the mobile device to receive camera data of an area around the mobile device;
identifying an object that is the selected item to be found from the camera data;
in response to identifying the object, determining a location of the object in the area around the mobile device; and
providing tactile instructions and/or audible instructions via the mobile device to the user to instruct the user where to move based on a position of the camera and the determined location of the object in the area around the mobile device.

2. The mobile device of claim 1, wherein the determining of the location of the object in the area around the mobile device includes:
generating a pre-selected number of location samples via ray casting; and
determining the location via averaging predicted locations determined for the pre-selected number of location samples such that the determined location is an average predicted location.

3. The mobile device of claim 2, wherein the method also comprises:
updating the determined location by obtaining a moving average based on a generation of additional location samples obtained via ray casting while the user moves the mobile device toward the object in response to the provided tactile instructions and/or audible instructions.

4. The mobile device of claim 1, wherein the mobile device is a cell phone, a mobile communication terminal, a smart phone, or a smart watch.

5. The mobile device of claim 1, wherein the method also comprises:
determining the position of the camera relative to the determined location of the object in the area around the mobile device, the position of the camera being a proxy for a hand of the user;
updating the determined location of the camera relative to the determined location of the object in the area around the mobile device to account for movement of the camera that occurs in response to the providing of the tactile instructions and/or audible instructions; and
providing updated tactile instructions and/or audible instructions via the mobile device to the user to instruct the user where to move based on the determined updated position of the camera and the determined location of the object in the area around the mobile device.

6. The mobile device of claim 1, wherein the method comprises:
generating a graphical user interface (GUI) on a display of the mobile device to display location information based on the determined location of the object in the area around the mobile device and the position of the camera.

7. The mobile device of claim 6, wherein the method comprises:
updating the GUI in response to selection of a guide icon to initiate the mobile device performing the providing of the tactile instructions and/or audible instructions via the mobile device to the user to instruct the user where to move so the user moves toward the object based on the position of the camera and the determined location of the object in the area around the mobile device.

8. The mobile device of claim 1, wherein the providing of the tactile instructions and/or the audible instructions comprises:
periodic emission of sound to indicate a proximity of the camera to the object; and
audible directional instruction output to the user to change a direction of the camera to move the mobile device closer to the object based on the determined location of the object in the area around the mobile device and a position of the camera relative to the determined location of the object.

9. A non-transitory computer readable medium having an application stored thereon, the application defining a method performed by a mobile device when a processor of the mobile device runs the application, the method comprising:
responding to input selecting an item to be found by utilizing at least one camera of the mobile device to receive camera data of an area around the mobile device;
identifying an object that is the selected item to be found from the camera data;
in response to identifying the object, determining a location of the object in the area around the mobile device;
providing tactile instructions and/or audible instructions via the mobile device to the user to instruct the user where to move based on a position of the camera and the determined location of the object in the area around the mobile device.

10. The non-transitory computer readable medium of claim 9, wherein the determining of the location of the object in the area around the mobile device includes:
generating a pre-selected number of location samples via ray casting; and
determining the location via averaging predicted locations determined for the pre-selected number of location samples.

11. The non-transitory computer readable medium of claim 10, wherein the method also comprises:
determining the position of the camera relative to the determined location of the object in the area around the mobile device, the position of the camera being a proxy for a hand of the user;
updating the determined location of the camera relative to the determined location of the object in the area around the mobile device to account for movement of the camera that occurs in response to the providing of the tactile instructions and/or audible instructions; and
providing updated tactile instructions and/or audible instructions via the mobile device to the user to instruct the user where to move based on the determined updated position of the camera and the determined location of the object in the area around the mobile device.

12. The non-transitory computer readable medium of claim 11, wherein the method also comprises:
updating the determined location by obtaining a moving average of the determined location based on a generation of additional location samples obtained via ray casting while the user moved the mobile device toward the object in response to the provided tactile instructions and/or audible instructions.

13. The non-transitory computer readable medium of claim 9, wherein the mobile device is a cell phone, a smart phone, a smart watch, or a mobile communication terminal.

14. The non-transitory computer readable medium of claim 9, wherein the method comprises:
generating a graphical user interface (GUI) on a display of the mobile device to display location information based on the determined location of the object in the area around the mobile device and a position of the camera.

15. The non-transitory computer readable medium of claim 14, wherein the method comprises:
updating the GUI in response to selection of a guide icon to initiate the mobile device performing the providing of the tactile instructions and/or audible instructions and/or tactile instructions via the mobile device to the user to instruct the user where to move so the user moves toward the object based on a position of the camera and the determined location of the object in the area around the mobile device.

16. The non-transitory computer readable medium of claim 9, any wherein the providing of the audible instructions comprises:
periodic emission of sound to indicate a proximity of the camera to the object; and
audible directional instruction output to the user to change a direction of the camera to move the mobile device closer to the object based on the determined location of the object in the area around the mobile device and a determined position of the camera relative to the object.

17. A method of providing hand guidance to direct a user toward an object via a mobile device, the method comprising:
the mobile device responding to input selecting an item to be found by utilizing at least one camera of the mobile device to receive camera data of an area around the mobile device;
the mobile device identifying an object that is the selected item to be found from the camera data;
in response to identifying the object, the mobile device determining a location of the object in the area around the mobile device; and
providing audible instructions and/or tactile instructions via the mobile device to the user to instruct the user where to move based on a position of the camera and the determined location of the object in the area around the mobile device.

18. The method of claim 17, wherein the providing of the audible instructions comprises:
periodic emission of sound to indicate a proximity of the camera to the object; and
audible directional instruction output to the user to change a direction of the camera to move the mobile device closer to the object based on the determined location of the object in the area around the mobile device and a position of the camera relative to the determined location of the object.

19. The method of claim 17, wherein the determining of the location of the object in the area around the mobile device includes:
generating a pre-selected number of location samples via ray casting; and
determining the location via averaging predicted locations determined for the pre-selected number of location samples such that the determined location is an average predicated location.

20. The method of claim 19, wherein the method also comprises:
updating the determined location by obtaining a moving average based on a generation of additional location samples obtained via ray casting while the user moves the mobile device toward the object in response to the provided audible instructions and/or tactile instructions.

21. The method of claim 17, comprising:
generating a graphical user interface (GUI) on a display of the mobile device that displays a list of selectable items to facilitate the receipt of the input selecting the item to be found.

22. The method of claim 21, comprising:
updating the display of the mobile device in response to receipt of the input selecting the item to be found on the display of the mobile device to display a selectable guide icon in the GUI that is selectable to initiate the mobile device performing the providing of the audible instructions and/or the tactile instructions.

23. The method of claim 17, comprising:
determining the position of the camera relative to the determined location of the object in the area around the mobile device, the position of the camera being a proxy for a hand of the user;
updating the determined location of the camera relative to the determined location of the object in the area around the mobile device to account for movement of the camera that occurs in response to the providing of the tactile instructions and/or audible instructions; and
providing updated tactile instructions and/or audible instructions via the mobile device to the user to instruct the user where to move based on the determined updated position of the camera and the determined location of the object in the area around the mobile device.

24. The method of claim 23, wherein the determining of the position of the camera relative to the determined location of the object is based on sensor data obtained via at least one sensor of the mobile device.

25. A mobile device for providing hand guidance to direct a user toward an object, the mobile device comprising:
a processor connected to a camera and a non-transitory computer readable medium having an application stored thereon;
the mobile device configured to concurrently track a position of a hand of the user and a location of an object based on camera data of an area around the object and sensor data of the mobile device to generate audible instructions and/or tactile instructions to output to a user to guide the user to the object independent of whether the object is within a line of sight of the camera after the location of the object is determined and also independent of whether a hand of the user is in sight of the camera.

26. The mobile device of claim 25, wherein the location of the object in the area around the mobile device is determined via a location determination process that includes:
generating a pre-selected number of location samples via ray casting; and
determining the location of the object via averaging predicted locations determined for the pre-selected number of location samples such that the determined location of the object is an average predicted location.

27. The mobile device of claim 26, wherein the location of the object is updated by obtaining a moving average based on a generation of additional location samples obtained via ray casting while the user moves the mobile device toward the object in response to the provided audible instructions and/or tactile instructions.

28. The mobile device of claim 25, wherein mobile device is configured to determine the position of the camera relative to the determined location of the object in the area around the mobile device, the position of the camera being a proxy for a hand of the user, and
the mobile device is configured to update the determined location of the camera relative to the determined location of the object in the area around the mobile device to account for movement of the camera that occurs in response to the tactile instructions and/or the audible instructions; and
the mobile device is configured to update the tactile instructions and/or audible instructions to instruct the user where to move based on the determined updated position of the camera and the determined location of the object in the area around the mobile device.

29. The mobile device of claim 25, wherein the mobile device is a cell phone, a mobile communication terminal, a smart phone, or a smart watch.

30. The mobile device of claim 25, wherein the mobile device is configured to determine the location of the object via one of: (i) utilization of ray casting, (ii) using an artificial intelligence to directly get a three dimensional location of the object from the camera data so that the location of the object is determined with respect to the camera, and (iii) utilizing feature matching to obtain a three dimensional location of the object with respect to the camera.
